(19) United States
(12) Patent Application Publication
(10) Pub. No.: US 2026/0264001 A1
(43) Pub. Date: Sep. 10, 2026

(54) SEPARATION FUNCTIONAL LAYER AND SEPARATION MEMBRANE

(71) Applicant: NITTO DENKO CORPORATION, Ibaraki-shi, Osaka (JP)

(72) Inventors: Tomoki YASUI, Ibaraki-shi, Osaka (JP); Yuri ITO, Ibaraki-shi, Osaka (JP); Shinya NISHIYAMA, Ibaraki-shi, Osaka (JP); Eiji KAMIO, Kobe-shi, Hyogo (JP); Kan KOBAYASHI, Kobe-shi, Hyogo (JP); Hideto MATSUYAMA, Kobe-shi, Hyogo (JP)

(21) Appl. No.: 19/155,223

(22) PCT Filed: Jan. 12, 2024
(86) PCT No.: PCT/JP2024/000643

§ 371 Date: Aug. 8, 2025

(30) Foreign Application Priority Data
Feb. 10, 2023 (JP) 2023-018949

(51) Int. Cl. B01D 53/22; B01D 69/02; B01D 69/14; B01D 71/38; B01D 71/44

(52) U.S. Cl. CPC B01D 53/228; B01D 69/02; B01D 69/1411; B01D 71/381; B01D 71/441; B01D 2256/16; B01D 2257/504; B01D 2325/04; B01D 2325/20; B01D 2325/24; B01D 2325/36; B01D 2325/52

(57) ABSTRACT

The present invention provides a new separation functional layer suitable for separating an acid gas from a gas mixture containing the acid gas. The separation functional layer of the present invention includes: an ionic liquid; a polymer A that is hydrophilic and forms a crystal structure in the ionic liquid; and a polymer B different from the polymer A. A separation membrane of the present invention includes: the separation functional layer; and a porous support member supporting the separation functional layer.

### TECHNICAL FIELD

The present invention relates to a separation functional layer and a separation membrane.

### BACKGROUND ART

A membrane separation method has been developed as a method for separating an acid gas such as carbon dioxide from a gas mixture containing the acid gas. The membrane separation method allows an efficient separation of an acid gas with a suppressed operation cost, compared with an absorption method according to which an acid gas contained in a gas mixture is absorbed by an absorbent to be separated.

Separation membranes used in the membrane separation method include a composite membrane in which a separation functional layer is formed on a porous support member. For example, Patent Literature 1 discloses a composite membrane including a structural body, as a separation functional layer, that includes an ionic liquid. In Patent Literature 1, the separation functional layer includes, in addition to the ionic liquid, a polymer network structure and an inorganic particle network structure formed from inorganic particles.

### CITATION LIST

### Patent Literature

Patent Literature 1: JP 2020-37688 A

### SUMMARY OF INVENTION

### Technical Problem

There is a demand for a new separation functional layer suitable for separating an acid gas from a gas mixture containing the acid gas.

### Solution to Problem

The present invention provides a separation functional layer including:
an ionic liquid;
a polymer A that is hydrophilic and forms a crystal structure in the ionic liquid; and
a polymer B different from the polymer A.

The present invention further provides a separation membrane including:
the above-mentioned separation functional layer; and
a porous support member supporting the separation functional layer.

The present invention further provides a separation membrane including:
a separation functional layer; and
a porous support member supporting the separation functional layer, wherein
the separation functional layer includes an ionic liquid, and a polymer A that is hydrophilic and forms a crystal structure in the ionic liquid.

### Advantageous Effects of Invention

The present invention makes it possible to provide a new separation functional layer suitable for separating an acid gas from a gas mixture containing the acid gas.

### BRIEF DESCRIPTION OF DRAWINGS

FIG. 1 is a cross-sectional view schematically showing a separation functional layer according to one embodiment of the present invention.

FIG. 2 is a cross-sectional view schematically showing a separation membrane according to one embodiment of the present invention.

FIG. 3 is a schematic cross-sectional view of a membrane separation device including the separation membrane of the present invention.

FIG. 4 is a perspective view schematically showing a modification of the membrane separation device including the separation membrane of the present invention.

FIG. 5 is a graph showing, with regard to the separation functional layer of each of Examples C1 to C12, a relation between a content of an ionic liquid and an ionic liquid leakage rate.

FIG. 6 is a graph showing, with regard to the separation functional layer of each of Examples C1 to C12, a relation between the content of the ionic liquid and a fracture energy of the separation functional layer.

FIG. 7 is a graph showing, with regard to the separation functional layer of each of Examples C1 to C12, a relation between the content of the ionic liquid and a fracture stress of the separation functional layer.

### DESCRIPTION OF EMBODIMENTS

A separation functional layer according to a first aspect of the present invention includes:
an ionic liquid;
a polymer A that is hydrophilic and forms a crystal structure in the ionic liquid; and
a polymer B different from the polymer A.

According to a second aspect of the present invention, for example, in the separation functional layer according to the first aspect, the ionic liquid is hydrophilic or amphiphilic.

According to a third aspect of the present invention, for example, in the separation functional layer according to the first or second aspect, the ionic liquid contains at least one selected from the group consisting of 1-ethyl-3-methylimidazolium dicyanamide and 1-ethyl-3-methylimidazolium tricyanomethanide.

According to a fourth aspect of the present invention, for example, in the separation functional layer according to any one of the first to third aspects, the polymer A has a hydroxyl group.

According to a fifth aspect of the present invention, for example, in the separation functional layer according to the fourth aspect, the polymer A is bonded to the polymer B via a hydrogen bond derived from the hydroxyl group.

According to a sixth aspect of the present invention, for example, in the separation functional layer according to any one of the first to fifth aspects, the polymer A includes polyvinyl alcohol.

According to a seventh aspect of the present invention, for example, in the separation functional layer according to any one of the first to sixth aspects, the polymer B has at least one selected from the group consisting of an amide group and an imide group.

According to an eighth aspect of the present invention, for example, in the separation functional layer according to any one of the first to seventh aspects, the polymer B is linear.

According to a ninth aspect of the present invention, for example, in the separation functional layer according to any one of the first to eighth aspects, the polymer B includes polyvinylpyrrolidone.

According to a tenth aspect of the present invention, for example, in the separation functional layer according to any one of the first to ninth aspects, a content of the ionic liquid is 60 wt % or more.

According to an eleventh aspect of the present invention, for example, the separation functional layer according to any one of the first to tenth aspects has a thickness of 100 μm or less.

According to a twelfth aspect of the present invention, for example, the separation functional layer according to any one of the first to eleventh aspects has a breaking strength of 100 kPa or more.

According to a thirteenth aspect of the present invention, for example, in the separation functional layer according to any one of the first to twelfth aspects, when a gas mixture composed of carbon dioxide and hydrogen is supplied to a space adjacent to one surface of the separation functional layer while a space adjacent to another surface of the separation functional layer is decompressed, a permeability of carbon dioxide permeating through the separation functional layer is 100 Barrer or more, a concentration of the carbon dioxide in the gas mixture is 50 vol % under a standard condition, the gas mixture supplied to the space adjacent to the one surface has a temperature of 30° C. and a pressure of 0.1 MPa, and the space adjacent to the other surface is decompressed in such a manner that a pressure in the space adjacent to the other surface is lower than an atmospheric pressure in a measurement environment by 0.1 MPa.

According to a fourteenth aspect of the present invention, for example, the separation functional layer according to any one of the first to thirteenth aspects is for use in separating an acid gas from a gas mixture containing the acid gas.

A separation membrane according to a fifteenth aspect of the present invention includes:
the separation functional layer according to any one of the first to fourteenth aspects; and
a porous support member supporting the separation functional layer.

A separation membrane according to a sixteenth aspect of the present invention includes:
a separation functional layer; and
a porous support member supporting the separation functional layer, wherein
the separation functional layer includes an ionic liquid, and a polymer A that is hydrophilic and forms a crystal structure in the ionic liquid.

The present invention will be described in detail below. The following description is not intended to limit the present invention to a specific embodiment.

### <Embodiment of Separation Functional Layer>

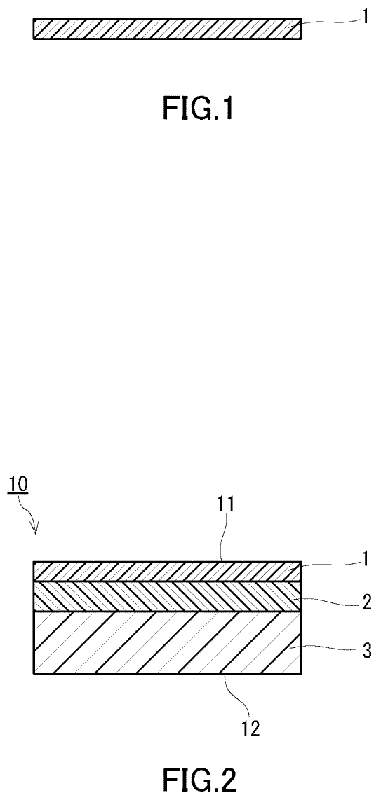

FIG. 1 is a cross-sectional view schematically showing a separation functional layer 1 of the present embodiment. The separation functional layer 1 includes: an ionic liquid L; a polymer A that is hydrophilic and forms a crystal structure in the ionic liquid L; and a polymer B different from the polymer A. In the separation functional layer 1, the ionic liquid L is present in a space between the polymer A and the polymer B and fills the space, for example. The separation functional layer 1 is typically an ionic gel membrane including the ionic liquid L. In the present description, the ionic liquid refers to a salt (ionic compound) that is liquid at 25° C.

The separation functional layer 1 of FIG. 1 can function as a self-supporting membrane (single-layer membrane). The separation functional layer 1 allows an acid gas contained in a gas mixture to preferentially permeate therethrough.

### (Ionic Liquid)

The ionic liquid L included in the separation functional layer 1 contains, for example, at least one selected from the group consisting of an imidazolium ion, a pyridinium ion, an ammonium ion, and a phosphonium ion, and preferably contains an imidazolium ion. These ions include, for example, a substituent having one or more carbon atoms.

Examples of the substituent having one or more carbon atoms include an alkyl group having 1 to 20 carbon atoms, a cycloalkyl group having 3 to 14 carbon atoms, and an aryl group having 6 to 20 carbon atoms, and these may be each further substituted by a hydroxy group, a cyano group, an amino group, a monovalent ether group, or the like (for example, a hydroxyalkyl group having 1 to 20 carbon atoms). Examples of the ether group include a polyalkylene glycol group such as polyethylene glycol.

Examples of the alkyl group having 1 to 20 carbon atoms include a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, an n-tridecyl group, an n-tetradecyl group, an n-pentadecyl group, an n-hexadecyl group, an n-heptadecyl group, an n-octadecyl group, an n-nonadecyl group, an n-eicosadecyl group, an i-propyl group, a sec-butyl group, an i-butyl group, a 1-methylbutyl group, a 1-ethylpropyl group, a 2-methylbutyl group, an i-pentyl group, a neopentyl group, a 1,2-dimethylpropyl group, a 1,1-dimethylpropyl group, a t-pentyl group, a 2-ethylhexyl group, and a 1,5-dimethylhexyl group. These may be each further substituted by a hydroxy group, a cyano group, an amino group, a monovalent ether group, or the like.

The above alkyl group may be substituted by a cycloalkyl group. The number of carbon atoms in the alkyl group substituted by the cycloalkyl group is, for example, 1 or more and 20 or less. Examples of the alkyl group substituted by the cycloalkyl group include a cyclopropyl methyl group, a cyclobutyl methyl group, a cyclohexyl methyl group, and a cyclohexyl propyl group. These may be each further substituted by a hydroxy group, a cyano group, an amino group, a monovalent ether group, or the like.

Examples of the cycloalkyl group having 3 to 14 carbon atoms include a cyclopropyl group, a cyclobutyl group, a cyclopentyl group, a cyclohexyl group, a cycloheptyl group, a cyclooctyl group, a cyclododecyl group, a norbornyl group, a bornyl group, and an adamantyl group. These may be each further substituted by a hydroxy group, a cyano group, an amino group, a monovalent ether group, or the like.

Examples of the aryl group having 6 to 20 carbon atoms include a phenyl group, a toluyl group, a xylyl group, a mesityl group, an anisyl group, a naphthyl group, and a benzyl group. These may be each further substituted by a hydroxy group, a cyano group, an amino group, a monovalent ether group, or the like.

In the present embodiment, the ionic liquid L preferably contains an imidazolium ion represented by the following formula (1).

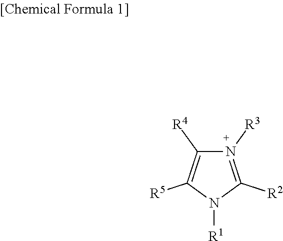

In the formula (1), R¹ to R⁵ are each independently a hydrogen atom or the above substituent having one or more carbon atoms. R¹ is preferably a substituent having one or more carbon atoms, more preferably an alkyl group having 1 to 20 carbon atoms, even more preferably an alkyl group having 2 to 10 carbon atoms, and particularly preferably an ethyl group or an n-butyl group. R³ is preferably a substituent having one or more carbon atoms, more preferably an alkyl group having 1 to 20 carbon atoms, even more preferably an alkyl group having 1 to 10 carbon atoms, and particularly preferably a methyl group. R², R⁴, and R⁵ are each preferably a hydrogen atom.

In the ionic liquid L, the above ion may form a salt with a counter anion. Examples of the counter anion include alkyl sulfate, tosylate, methanesulfonate, trifluoromethanesulfonate, toluenesulfonate, acetate, bis(fluorosulfonyl)imide, bis(trifluoromethanesulfonyl)imide, thiocyanate, dicyanamide, tricyanomethanide, tetracyanoborate, hexafluorophosphate, tetrafluoroborate, and halide. Preferred are dicyanamide, tetrafluoroborate, and tricyanomethanide.

Specific examples of the ionic liquid L include 1-ethyl-3-methylimidazolium bis(trifluoromethanesulfonyl)imide, 1-ethyl-3-methylimidazolium bis(fluorosulfonyl)imide, 1-ethyl-3-methylimidazolium dicyanamide, 1-butyl-3-methylimidazolium bromide, 1-butyl-3-methylimidazolium chloride, 1-butyl-3-methylimidazolium tetrafluoroborate, 1-butyl-3-methylimidazolium hexafluorophosphate, 1-butyl-3-methylimidazolium trifluoromethanesulfonate, 1-butyl-3-methylimidazolium tetrachloroferrate, 1-butyl-3-methylimidazolium iodide, 1-butyl-2,3-dimethylimidazolium chloride, 1-butyl-2,3-dimethylimidazolium hexafluorophosphate, 1-butyl-2,3-dimethylimidazolium tetrafluoroborate, 1-butyl-3-methylimidazolium bis(trifluoromethanesulfonyl)imide, 1-butyl-2,3-dimethylimidazolium bis(trifluoromethanesulfonyl)imide, 1-butyl-3-methylimidazolium trifluoro(trifluoromethyl)borate, 1-butyl-3-methylimidazolium tribromide, 1,3-dimesitylimidazolium chloride, 1,3-bis(2,6-diisopropylphenyl)imidazolium chloride, 1,3-diisopropylimidazolium tetrafluoroborate, 1,3-di-tert-butylimidazolium tetrafluoroborate, 1,3-dicyclohexylimidazolium tetrafluoroborate, 1,3-dicyclohexylimidazolium chloride, 1,2-dimethyl-3-propylimidazolium iodide, 1-hexyl-3-methylimidazolium chloride, 1-hexyl-3-methylimidazolium hexafluorophosphate, 1-hexyl-3-methylimidazolium tetrafluoroborate, 1-hexyl-3-methylimidazolium bromide, 1-methyl-3-propylimidazolium iodide, 1-methyl-3-n-octylimidazolium bromide, 1-methyl-3-n-octylimidazolium chloride, 1-methyl-3-n-octylimidazolium hexafluorophosphate, 1-methyl-3-[6-(methylsulfinyl)hexyl]imidazolium p-toluenesulfonate, 1-ethyl-3-methylimidazolium tetrafluoroborate,1-ethyl-3-methylimidazolium tricyanomethanide, 1-ethyl-3-methylimidazolium tetracyanoborate, and 1-(2-hydroxyethyl)-3-methylimidazolium bis(trifluoromethanesulfonyl)imide.

The ionic liquid L included in the separation functional layer 1 is preferably hydrophilic or amphiphilic. A combination of the ionic liquid L that is hydrophilic or amphiphilic and the polymer A that is hydrophilic tends to enhance mechanical strength of the separation functional layer 1.

Herein, the phrase “an ionic liquid is hydrophilic” means that the ionic liquid dissolves in water in Test 1 below, while the ionic liquid does not dissolve in isopropyl alcohol (IPA) and phase separation is confirmed in Test 2 below. The phrase “an ionic liquid is amphiphilic” means that the ionic liquid dissolves in water in Test 1 below and the ionic liquid dissolves in IPA in Test 2 below.

Test 1: At room temperature (25° C.), 0.5 g of an ionic liquid is added into a container such as a micro tube, into which 0.5 g of water (ion-exchange water) is further added. Subsequently, the container is hermetically sealed, and is shaken by hand about 10 times. The container is allowed to stand still for one minute, and then whether the ionic liquid is dissolved in the water in the container is visually checked.

Test 2: At room temperature, 0.5 g of an ionic liquid is added into a container such as a micro tube, into which 0.5 g of IPA is further added. Subsequently, the container is hermetically sealed, and is shaken by hand about 10 times. The container is allowed to stand still for one minute, and then whether the ionic liquid is dissolved in the IPA in the container is visually checked.

Herein, in the case where an ionic liquid does not dissolve in water and phase separation is confirmed in Test 1, the ionic liquid is judged hydrophobic.

Examples of the ionic liquid L that is hydrophilic or amphiphilic include 1-ethyl-3-methylimidazolium dicyanamide ([EMIM][DCA]), and 1-ethyl-3-methylimidazolium tricyanomethanide ([EMIM][TCM]). The ionic liquid L preferably includes at least one selected from the group consisting of [EMIM][DCA] and [EMIM][TCM], and more preferably includes [EMIM][DCA]. [EMIM][DCA] is suitable for enhancing acid gas permeation performance of the separation functional layer 1.

From the viewpoint of gas separation performance, the content of the ionic liquid L in the separation functional layer 1 is, for example, 5 wt % or more, and may be 30 wt % or more, 50 wt % or more, 60 wt % or more, 70 wt % or more, or even 80 wt % or more. The higher the content of the ionic liquid L is, the more enhanced separation performance the separation functional layer 1 tends to have. The upper limit of the content of ionic liquid L is, for example, but not particularly limited to, 95 wt % or less, and may be 90 wt % or less. When the content of the ionic liquid L is 95 wt % or less, the self-supporting property of the separation functional layer 1 tends to be secured.

In the separation functional layer 1, the weight ratio of the ionic liquid L with respect to the polymers (the polymers A and B) is, for example, but not particularly limited to, 50/50 to 90/10.

### (Polymer A)

As described above, the polymer A forms a crystal structure in the ionic liquid L. In other words, the polymer A is crystallized in the ionic liquid L. In the ionic liquid L, the polymer A may be fully crystallized, but it is preferable that the polymer A be partially crystallized. In one example, in the ionic liquid L, a part of the polymer A may be crystallized and another part of the polymer A may swell with the ionic liquid L. The phrase “the polymer A forms a crystal structure in the ionic liquid L” means that when a sample including the polymer A and the ionic liquid L is subjected to an X-ray diffraction (XRD) measurement at a room temperature (25° C.), a peak derived from a crystal structure of the polymer A can be observed. The sample used for the XRD measurement is prepared by dissolving 1.3 g of the polymer A in a liquid mixture composed of 5 g of the ionic liquid L and 10.24 g of water, drying the obtained solution at 30° C. for 24 hours, and then further drying the solution at 70° C. for 24 hours. The solution can be dried using a laboratory dish made from polytetrafluoroethylene (PTFE), for example.

The crystallization of the polymer A is, for example, derived from the fact that a plurality of molecules of the polymer A are physically crosslinked in the ionic liquid L. The physical crosslinking means that a plurality of polymer molecules are aggregated by an interaction such as an intermolecular force. It can be said that the polymer A has a physical crosslinking point in the ionic liquid L. Note that the polymer A does not have a chemically crosslinked structure, for example. The chemical crosslinking means that a plurality of polymer molecules are bonded to each other via a covalent bond.

Furthermore, the polymer A is hydrophilic in the present embodiment. Herein, the phrase “a polymer is hydrophilic” means that a distance Ra between Hansen solubility parameters of the polymer and Hansen solubility parameters of H₂O is less than 19 MPa^{1/2}.

The Hansen solubility parameters are parameters obtained by dividing a solubility parameter introduced by Hildebrand into three components of a dispersion term 6D, a polar term 6P, and a hydrogen bonding term SH. The details of the Hansen solubility parameters are disclosed in “Hansen Solubility Parameters; A Users Handbook (CRC Press, 2007)”. The Hansen solubility parameters can be calculated, for example, using known software such as HSPiP.

The distance Ra between the Hansen solubility parameters of the polymer and the Hansen solubility parameters of H₂O can be calculated by the following formula (i). In the formula (i), δD₁, δP₁, and δH₁ are respectively a dispersion term (MPa^{1/2}), a polar term (MPa^{1/2}), and a hydrogen bonding term (MPa^{1/2}) of the polymer. Symbols δD₂, δP₂, and δH₂ are respectively a dispersion term (18.1 MPa^{1/2}), a polar term (17.1 MPa^{1/2}), and a hydrogen bonding term (16.9 MPa^{1/2}) of H₂O.

$$Ra = {\{ 4 \times {( δ {D}_{1} - δ {D}_{2} )}^{2} + {( δ {P}_{1} - δ {P}_{2} )}^{2} + {( δ {H}_{1} - δ {H}_{2} )}^{2} \}}^{1 / 2} \qquad ( i )$$

A distance Ra1 between Hansen solubility parameters of the polymer A and the Hansen solubility parameters of H₂O is preferably 18 MPa^{1/2} or less, and may be 17 MPa^{1/2} or less, 16 MPa^{1/2} or less, 15 MPa^{1/2} or less, 14 MPa^{1/2} or less, 13 MPa^{1/2} or less, 12 MPa^{1/2} or less, 11 MPa^{1/2} or less, 10 MPa^{1/2} or less, or even 9 MPa^{1/2} or less. The lower limit of the distance Ra1 is, for example, but not particularly limited to, 3 MPa^{1/2} or more, and may be 5 MPa^{1/2} or more.

The polymer A may be a homopolymer or a copolymer. Examples of the copolymer include a random copolymer, a block copolymer, an alternating copolymer, and a graft copolymer. Preferably, the polymer A is linear and does not have a branched structure. However, the polymer A may have a branched structure. In the present description, the phrase “a polymer is linear” means that structural units included in the polymer are linearly arranged without being branched.

The polymer A preferably has a polar group such as a hydroxyl group. In one example, the polymer A is hydrophilic because of the polar group. In the separation functional layer 1, it is preferable that the polymer A have a hydroxyl group and be bonded to the polymer B via a hydrogen bond derived from the hydroxyl group. In this case, the separation functional layer 1 tends to have a high mechanical strength.

The polymer A preferably includes polyvinyl alcohol (PVA). PVA can, for example, form a crystal structure in the ionic liquid L such as [EMIM][DCA] and [EMIM][TCM]. Furthermore, the distance Ra between Hansen solubility parameters of PVA and the Hansen solubility parameters of H₂O is around 8.1 MPa^{1/2}, and it can be said that PVA is hydrophilic.

A saponification degree of PVA as the polymer A is preferably 70 mol % or more, and may be 75 mol % or more, 80 mol % or more, or even 85 mol % or more. The saponification degree of PVA may be 90 mol % or more in some cases. The upper limit of the saponification degree of PVA is, for example, but not particularly limited to, 99 mol % or less, and may be 95 mol % or less, or 85 mol % or less in some cases. In the case where PVA with a low saponification degree is used as the polymer A, the leakage of the ionic liquid L from the separation functional layer 1 tends to be further suppressed. The saponification degree of PVA can be measured in accordance with Japanese Industrial Standards (JIS) K6726:1994.

A weight-average molecular weight of the polymer A is preferably 10000 or more, and may be 30000 or more, or even 50000 or more. The weight-average molecular weight of the polymer A may be 130000 or more in some cases. The higher the weight-average molecular weight of the polymer A is, the more enhanced mechanical strength the separation functional layer 1 tends to have. The upper limit of the weight-average molecular weight of the polymer A is, for example, but not particularly limited to, 300000 or less, and may be 200000 or less. For example, a molecular weight distribution of the polymer A is measured by gel permeation chromatograph (GPC) including a differential refractive index detector (RID) so that the weight-average molecular weight of the polymer A can be calculated from the obtained chromatogram (chart) using a calibration curve of standard polystyrene.

The content of the polymer A in the separation functional layer 1 is, for example, but not particularly limited to, 1 wt % or more, and may be 5 wt % or more, 10 wt % or more, 15 wt % or more, or even 20 wt % or more. The higher the content of the polymer A is, the more enhanced strength the separation functional layer 1 tends to have. The upper limit of the content of the polymer A is, for example, but not particularly limited to, 30 wt % or less, and may be 20 wt % or less in some cases.

### (Polymer B)

As described above, the polymer B is different from the polymer A.

Specifically, the polymer A and the polymer B have different compositions. The polymer B forms no crystal structure in the ionic liquid L, for example. In other words, the polymer B has a higher solubility in the ionic liquid L than that of the polymer A.

The polymer B is preferably hydrophilic. However, the polymer B does not need to be hydrophilic. A distance Ra2 between Hansen solubility parameters of the polymer B and the Hansen solubility parameters of H₂O is, for example, 30 MPa^{1/2} or less, and preferably less than 19 MPa^{1/2}. The lower limit of the distance Ra2 is, for example, but not particularly limited to, 3 MPa^{1/2} or more, and may be 5 MPa^{1/2} or more.

In the case where the polymer A has a hydroxyl group, the polymer B preferably has a functional group that can form a hydrogen bond with the hydroxyl group. Examples of such a functional group include an amide group and an imide group. The polymer B preferably has at least one selected from the group consisting of an amide group and an imide group, and more preferably has an amide group. In one example, the polymer B may have a ring structure (lactam structure) including an amide group.

In a preferred embodiment of the present invention, the polymer B does not have a chemically crosslinked structure. The polymer B may be a homopolymer or a copolymer. As the copolymer, those stated above for the polymer A can be mentioned. Preferably, the polymer B is linear and does not have a branched structure. Examples of the polymer B that does not have a chemically crosslinked structure include polyvinylpyrrolidone (PVP).

In another preferred embodiment of the present invention, the polymer B has a chemically crosslinked structure. In other words, the polymer B is a crosslinked product of a prepolymer. Hereinafter, an aspect in which the polymer B is a crosslinked product of a prepolymer will be explained in detail.

### [Prepolymer]

A prepolymer for forming the polymer B has a polymer chain including a structural unit derived from a monomer. This polymer chain is formed by, for example, radical polymerization of a monomer. In a crosslinked product of the prepolymer, a plurality of the polymer chains are crosslinked via a crosslinking chain. The polymer chain and the crosslinking chain are preferably bonded to each other by at least one bond selected from the group consisting of hydrazone bond, amide bond, imide bond, urethane bond, ether bond, and ester bond.

The prepolymer may be a homopolymer, a copolymer, or a mixture of these. As the copolymer, those stated above for the polymer A can be mentioned. In one example, the prepolymer may include a (meth)acrylic polymer. The (meth)acrylic polymer is a polymer having a structural unit U derived from a monomer b including a (meth)acrylic group and/or a (meth)acrylamide group. The (meth)acrylic polymer may have the structural unit U, as a main component, derived from the monomer b and be composed substantially of the structural unit U alone, for example. However, the (meth)acrylic polymer may further include an additional structural unit other than the structural unit U. Note that in the present description, the term “(meth)acrylic” means acrylic and/or methacrylic. Usually, when a prepolymer includes a (meth)acrylic polymer, a crosslinked product of the prepolymer can also be referred to as a (meth)acrylic polymer. That is, the polymer B may be a (meth)acrylic polymer.

The prepolymer is preferably a polymer having a crosslinking point that can react with the later-described crosslinking agent. The crosslinking point is located at an end, a main chain, or a side chain of the prepolymer. From the viewpoint that a crosslinked product crosslinked highly three-dimensionally can be obtained, the crosslinking point is preferably located at a side chain of the prepolymer.

The prepolymer preferably has a functional group, particularly a polar group, that functions as the crosslinking point. The polar group refers to an atomic group including an atom other than a carbon atom and a hydrogen atom, and typically refers to an atomic group including at least one selected from the group consisting of an N atom and an O atom. When the prepolymer has the polar group, it is possible to obtain easily a crosslinked product crosslinked highly three-dimensionally. Also, the crosslinked product of the prepolymer having the polar group tends to be able to hold the ionic liquid in a stable manner.

Examples of the polar group include an amino group, an amide group, an imide group, a morpholino group, a carboxyl group, an ester group, a hydroxyl group, and an ether group. Examples of the amino group include not only a primary amino group but also a secondary amino group and a tertiary amino group that are substituted by an alkyl group or the like. Examples of the amide group include a (meth)acrylamide group, an acetamide group, and a pyrrolidone group. Examples of the ether group include: a polyalkyl ether group such as a polyethylene glycol group or a polypropylene glycol group; an epoxy group; and a vinyloxy group.

The prepolymer preferably includes a structural unit derived from a polar group-containing monomer. The polar group-containing monomer preferably includes, for example, at least one selected from the group consisting of an amide group-containing monomer, an imide group-containing monomer, an amino group-containing monomer, an epoxy group-containing monomer, a vinyloxy group-containing monomer, a carboxyl group-containing monomer, and a hydroxyl group-containing monomer. More preferably, the polar group-containing monomer includes at least one selected from the group consisting of an amide group-containing monomer, an imide group-containing monomer, a vinyloxy group-containing monomer, and a carboxyl group-containing monomer.

Examples of the amide group-containing monomer include acrylamide, methacrylamide, N-vinylpyrrolidone, N,N-diallylacrylamide, N-methylacrylamide, N,N-dimethylacrylamide, N,N-dimethylmethacrylamide, N,N-diethylacrylamide, N,N-diethylmethacrylamide, N,N′-methylenebisacrylamide, N,N-dimethylaminopropylacrylamide, N,N-dimethylaminopropyl methacrylamide, and diacetone acrylamide.

Examples of the imide group-containing monomer include N-(meth)acryloyloxy succinimide, N-(meth)acryloyloxy methylenesuccinimide, and N-(meth)acryloyloxy ethylenesuccinimide.

Examples of the amino group-containing monomer include aminoethyl (meth)acrylate, N,N-dimethylaminoethyl (meth)acrylate, and N,N-dimethylaminopropyl (meth)acrylate.

Examples of the epoxy group-containing monomer include glycidyl (meth)acrylate, methylglycidyl (meth)acrylate, 3-ethyloxetane-3-yl(meth)acrylate, and allyl glycidyl ether.

Examples of the vinyloxy group-containing monomer include (meth)acrylic acid 2-(2-vinyloxyethoxy) ethyl, (meth)acrylic acid 2-vinyloxyethyl, and (meth)acrylic acid 4-vinyloxypropyl.

Examples of the carboxyl group-containing monomer include (meth)acrylic acid.

Examples of the hydroxyl group-containing monomer include 4-hydroxybutyl (meth)acrylate.

One of these polar group-containing monomers may be used alone or two or more of them may be used in combination. For example, the prepolymer may be formed by copolymerizing N-methylacrylamide or N,N-dimethylacrylamide (DMAAm) with N,N′-methylenebisacrylamide, diacetone acrylamide (DAAm), N-acryloyloxysuccinimide (NSA), or the like. In one example, the prepolymer may include a structural unit derived from N,N-dimethylacrylamide and a structural unit derived from N-acryloyloxysuccinimide, or may be a copolymer of N,N-dimethylacrylamide and N-acryloyloxysuccinimide.

The prepolymer may include a structural unit derived from a monomer other than the polar group-containing monomer. Examples of the other monomer include alkyl (meth)acrylate such as methyl (meth)acrylate or n-butyl (meth)acrylate. In one example, the prepolymer may include a structural unit derived from n-butyl (meth)acrylate and a structural unit derived from (meth)acrylic acid, or may be a copolymer of n-butyl (meth)acrylate and (meth)acrylic acid.

The polymer B includes, for example, at least one selected from the group consisting of a structure derived from a copolymer of N,N-dimethylacrylamide and N-acryloyloxysuccinimide, and a structure derived from a copolymer of n-butyl (meth)acrylate and (meth)acrylic acid. The polymer B preferably includes a structure derived from a copolymer of N,N-dimethylacrylamide and N-acryloyloxysuccinimide.

The prepolymer may include a structural unit that functions as a crosslinking agent, such as a structural unit derived from polyfunctional (meth)acrylate. The prepolymer having this structural unit is self-crosslinkable. The polyfunctional (meth)acrylate refers to a monomer having two or more (meth)acrylic groups in one molecule thereof. Examples of the polyfunctional (meth)acrylate include trimethylolpropane tri(meth)acrylate, pentaerythritol tetra(meth)acrylate, 1,2-ethylene glycol di(meth)acrylate, 1,6-hexanediol di(meth)acrylate, and dipentaerythritol hexaacrylate.

From the viewpoint of mechanical strength of the separation functional layer 1, a weight-average molecular weight (Mw) of the prepolymer is preferably 2500 or more, for example, and more preferably 5000 or more, and still more preferably 10000 or more. The upper limit of the weight-average molecular weight of the prepolymer is, for example, but not particularly limited to, 2500000, preferably 1000000, and more preferably 750000. The weight-average molecular weight of the prepolymer can be specified by the method mentioned above for the polymer A.

The prepolymer can be obtained by, for example, polymerizing, in the presence of a polymerization initiator, a monomer having a functional group that functions as the crosslinking point. The polymerization of the monomer is preferably radical polymerization from the viewpoint of improving the flexibility and stretchability of the separation functional layer 1. The radical polymerization may be thermal polymerization, or may be photopolymerization (polymerization by UV irradiation, for example).

As the polymerization initiator, an azo-based polymerization initiator, a peroxide-based initiator, a redox-based initiator obtained by combining a peroxide and a reducing agent, a substituted ethane-based initiator or the like can be used. When photopolymerization is performed, various kinds of photopolymerization initiators can be used. A photosensitizer, such as 2-oxoglutaric acid, may be used for the photopolymerization.

Examples of the azo-based polymerization initiator include 2,2′-azobisisobutyronitrile (AIBN), 2,2′-azobis-2-methylbutyronitrile, dimethyl-2,2′-azobis(2-methyl propionate), 4,4′-azobis-4-cyanovaleric acid, azobisisovaleronitrile, 2,2′-azobis(2-amidinopropane) dihydrochloride, 2,2′-azobis[2-(5-methyl-2-imidazoline-2-yl) propane]dihydrochloride, 2,2′-azobis(2-methylpropionamidin) disulfate, and 2,2′-azobis(N,N′-dimethyleneisobutylamidine) dihydrochloride.

Examples of the peroxide-based initiator include: persulfate such as potassium persulfate or ammonium persulfate; dibenzoyl peroxide, t-butyl permaleate, t-butyl hydroperoxide, di-t-butyl peroxide, t-butylperoxy benzoate, dicumyl peroxide, 1,1-bis(t-butylperoxy)-3,3,5-trimethylcyclohexane, 1,1-bis(t-butylperoxy)cyclododecane, and hydrogen peroxide.

Examples of the redox-based initiator include a combination of a peroxide and ascorbic acid (such as a combination of a hydrogen peroxide solution and ascorbic acid), a combination of a peroxide and an iron(II) salt (such as a combination of a hydrogen peroxide solution and an iron(II) salt), and a combination of persulfate and sodium hydrogensulfite.

Examples of the substituted ethane-based initiator include phenyl-substituted ethane.

As the photopolymerization initiators, there can be mentioned an acetophenone-based photopolymerization initiator, a ketal-based photopolymerization initiator, a benzophenone-based photopolymerization initiator, a benzoin-based photopolymerization initiator, a benzoyl-based photopolymerization initiator, a xanthone-based photopolymerization initiator, active halogen compounds (a triazine-based photopolymerization initiator, a halomethyl oxadiazole-based photopolymerization initiator, and a coumarin-based photopolymerization initiator), an acridine-based photopolymerization initiator, a biimidazole-based photopolymerization initiator, and an oxime ester-based photopolymerization initiator.

Examples of the acetophenone-based photopolymerization initiator include 2,2-diethoxyacetophenone, p-dimethylaminoacetophenone, 2-hydroxy-2-methyl-1-phenyl-propane-1-one, p-dimethylaminoacetophenone, 4′-isopropyl-2-hydroxy-2-methyl-propiophenone, 1-hydroxycyclohexyl phenyl ketone, 2-benzyl-2-dimethylamino-1-(4-morpholinophenyl)-1-butanone, 2-tolyl-2-dimethylamino-1-(4-morpholinophenyl)-1-butanone, and 2-methyl-1-[4-(methylthio)phenyl]-2-morpholino-1-propanone.

Examples of the ketal-based photopolymerization initiator include benzyl dimethylketal and benzyl-p-methoxyethyl acetal.

Examples of the benzophenone-based photopolymerization initiator include benzophenone, 4,4′-(bisdimethylamino)benzophenone, 4,4′-(bisdiethylamino)benzophenone, and 4,4′-dichlorobenzophenone.

Examples of the benzoin-based or the benzoyl-based photopolymerization initiator include benzoin isopropyl ether, benzoin isobutyl ether, benzoin methyl ether, and methyl o-benzoylbenzoate.

Examples of the xanthone-based photopolymerization initiator include diethylthioxanthone, diisopropylthioxanthone, monoisopropylthioxanthone, and chlorothioxanthone.

Examples of the triazine-based photopolymerization initiator include 2,4-bis(trichloromethyl)-6-p-methoxyphenyl-s-triazine, 2,4-bis(trichloromethyl)-6-p-methoxystyryl-s-triazine, 2,4-bis(trichloromethyl)-6-(1-p-dimethylaminophenyl)-1,3-butadienyl-s-triazine, 2,4-bis(trichloromethyl)-6-biphenyl-s-triazine, 2,4-bis(trichloromethyl)-6-(p-methylbiphenyl)-s-triazine, p-hydroxy ethoxystyryl-2,6-di(trichloromethyl)-s-triazine, methoxystyryl-2,6-di(trichloromethyl)-s-triazine, 3,4-dimethoxystyryl-2,6-di(trichloromethyl)-s-triazine, 4-benzoxolane-2,6-di(trichloromethyl)-s-triazine, 4-(o-bromo-p-N,N-(diethoxy carbonylamino)-phenyl)-2,6-di(chloromethyl)-s-triazine, and 4-(p-N,N-diethoxy carbonylamino)-phenyl)-2,6-di(chloromethyl)-s-triazine.

Examples of the halomethyl oxadiazole-based photopolymerization initiator include 2-trichloromethyl-5-styryl-1,3,4-oxodiazole, 2-trichloromethyl-5-(cyanostyryl)-1,3,4-oxodiazole, 2-trichloromethyl-5-(naphtho-1-yl)-1,3,4-oxodiazole, and 2-trichloromethyl-5-(4-styryl)styryl-1,3,4-oxodiazole.

Examples of the coumarin-based photopolymerization initiator include 3-methyl-5-amino-((s-triazine-2-yl)amino)-3-phenylcoumarin, 3-chloro-5-diethylamino-((s-triazine-2-yl)amino)-3-phenylcoumarin, and 3-butyl-5-dimethylamino-((s-triazine-2-yl)amino)-3-phenylcoumarin.

Examples of the acridine-based photopolymerization initiator include 9-phenylacridine and 1,7-bis(9-acridinyl)heptane.

Examples of the biimidazole-based photopolymerization initiator include: a Iophine dimer such as a 2-(o-chlorophenyl)-4,5-diphenylimidazolyl dimer, a 2-(o-methoxyphenyl)-4,5-diphenylimidazolyl dimer, or a 2-(2,4-dimethoxyphenyl)-4,5-diphenylimidazolyl dimer; 2-mercaptobenzimidazole; and 2,2′-dibenzothiazolyl disulfide.

Examples of the oxime ester-based photopolymerization initiator include 1,2-octanedione 1-[4-(phenylthio)-2-(O-benzoyloxime)], and ethanone 1-[9-ethyl-6-(2-methylbenzoyl)-9H-carbazole-3-yl]-1-(0-acetyloxime).

One of these polymerization initiators can be used alone or two or more of them can be used in combination. The polymerization initiator is preferably 2,2′-azobisisobutyronitrile. An amount of the polymerization initiator is, for example, but not particularly limited to, 0.1 parts by mass or more, and preferably 0.3 parts by mass or more, with respect to 100 parts by mass of the monomer. The amount of the polymerization initiator is preferably 3 parts by mass or less, and more preferably 2 parts by mass or less, with respect to 100 parts by mass of the monomer.

The prepolymer may be synthesized in the presence of a solvent. As the solvent, an organic solvent is preferred, and examples thereof include: a ketone-based organic solvent such as acetone, methyl ethyl ketone, or methyl isobutyl ketone; an ester-based organic solvent such as methyl acetate, ethyl acetate, or butyl acetate; a polar solvent such as dimethylformamide, dimethyl sulfoxide, or N-methyl-2-pyrrolidone; an alcohol-based organic solvent such as methyl alcohol, ethyl alcohol, or isopropyl alcohol; an aromatic hydrocarbon-based organic solvent such as toluene or xylene; an aliphatic hydrocarbon-based or alicyclic hydrocarbon-based organic solvent such as n-hexane, cyclohexane, or methylcyclohexane; a cellosolve-based organic solvent such as methyl cellosolve, ethyl cellosolve, or butyl cellosolve; an ether-based organic solvent such as tetrahydrofuran or dioxane; and a carbitol-based organic solvent such as n-butyl carbitol or iso-amyl carbitol. One of these organic solvents can be used alone or two or more of them can be used in combination.

The method for synthesizing the prepolymer is not particularly limited and known methods such as solution polymerization, emulsion polymerization, block polymerization, suspension polymerization, atom transfer radical polymerization (ATRP), and reversible addition fragmentation chain transfer (RAFT) polymerization can be used. However, from the viewpoint of workability, solution polymerization is preferred. In one example, the prepolymer may be synthesized by photopolymerization in the presence of the solvent, or may be synthesized by photopolymerization, particularly UV polymerization, without the presence of the solvent.

Examples of the ATRP initiator include alkyl halide such as 2-bromoisobutyric acid tert-butyl ester, 2-bromoisobutyric acid methyl ester, 2-bromoisobutyryl bromide, 2-bromoisobutyric acid ethyl ester, 2-bromoisobutyric acid 2-hydroxyethyl ester, ethylene bis(2-bromoisobutyrate), 1-tris(hydroxymethyl)ethane, or pentaerythritol tetrakis(2-bromoisobutyrate).

Examples of a ligand for an ATRP catalyst include 2,2′-bipyridyl, 4,4′-dimethyl-2,2′-dipyridine, 4,4′-di-tert-butyl-2,2′-dipyridyl, 4,4′-dinonyl-2,2′-dipyridyl, N-butyl-2-pyridylmethanimine, N-octyl-2-pyridylmethanimine, N-dodecyl-N-(2-pyridylmethylene)amine, N-octadecyl-N-(2-pyridylmethylene)amine, and N,N,N′,N″,N″-pentamethyldiethylenetriamine.

Examples of a metal salt for the ATRP catalyst include copper(I) chloride, copper(II) chloride, copper(I) bromide, copper(II) bromide, titanium(II) chloride, titanium(III) chloride, titanium(IV) chloride, titanium(IV) bromide, and iron(II) chloride.

Examples of a RAFT agent include cyanomethyl-dodecyl trithiocarbonate, 2-(dodecylthiocarbonothioylthio)-2-methylpropionic acid, and 2-cyano-2-propyl dodecyl trithiocarbonate.

When the prepolymer is synthesized by thermal polymerization, the polymerization temperature is, for example, 25 to 80° C., preferably 30 to 70° C., and more preferably 40 to 60° C. When the prepolymer is synthesized by photopolymerization, the polymerization temperature is preferably 10 to 60° C., more preferably 20 to 50° C., and still more preferably 20 to 40° C.

When the prepolymer is synthesized by thermal polymerization, the polymerization time is, for example, 1 to 100 hours, preferably 20 to 80 hours, more preferably 30 to 70 hours, and still more preferably 40 to 60 hours. When the prepolymer is synthesized by photopolymerization, the polymerization time is, for example, 0.1 to 100 hours, preferably 1 to 70 hours, more preferably 5 to 40 hours, and still more preferably 10 to 30 hours.

When the prepolymer is synthesized by photopolymerization, the wavelength of ultraviolet rays to be used is not particularly limited as long as the monomer is radically polymerizable. The wavelength of ultraviolet rays can be selected from a wavelength range of 200 to 550 nm, for example, and it is preferably 250 to 500 nm, and more preferably 300 to 400 nm. The strength of the ultraviolet rays is not particularly limited. However, considering the polymerization time and safety, it is, for example, 1 to 3000 mJ/(cm²·s), and preferably 10 to 2000 mJ/(cm²·s).

### [Crosslinking Agent]

The polymer B can be formed by a reaction between the prepolymer and a crosslinking agent, for example. However, when the prepolymer includes a structural unit that functions as a crosslinking agent, the polymer B can be formed by a reaction between the prepolymers. The crosslinking agent can be suitably selected depending on a composition of the prepolymer, etc. Examples of the crosslinking agent include polyfunctional (meth)acrylate, a hydrazide-based crosslinking agent, an amine-based crosslinking agent, an isocyanate-based crosslinking agent, an epoxy-based crosslinking agent, an aziridine-based crosslinking agent, a melamine-based crosslinking agent, a metal chelate-based crosslinking agent, a metal salt-based crosslinking agent, a peroxide-based crosslinking agent, an oxazoline-based crosslinking agent, a urea-based crosslinking agent, a carbodiimide-based crosslinking agent, and a coupling agent-based crosslinking agent (such as a silane coupling agent). One of these crosslinking agents can be used alone or two or more of them can be used in combination. The polymer B is preferably a crosslinked product obtained by using at least one crosslinking agent selected from the group consisting of an amine-based crosslinking agent and an epoxy-based crosslinking agent. More preferably, the polymer B is a crosslinked product obtained by using an amine-based crosslinking agent, specifically a product obtained by a reaction between the prepolymer and an amine-based crosslinking agent.

As the polyfunctional (meth)acrylate, those stated above for the prepolymer can be mentioned.

Examples of the hydrazide-based crosslinking agent include multivalent hydrazides such as isophthalic acid dihydrazide, terephthalic acid dihydrazide, phthalic acid dihydrazide, 2,6-naphthalene dicarboxylic acid dihydrazide, naphthalene acid dihydrazide, oxalic acid dihydrazide, malonic acid dihydrazide, succinic acid dihydrazide, glutamic acid dihydrazide, adipic acid dihydrazide, pimelic acid dihydrazide, suberic acid dihydrazide, azelaic acid dihydrazide, sebacic acid dihydrazide, brassylic acid dihydrazide, dodecanedioic acid dihydrazide, acetonedicarboxylic acid dihydrazide, fumaric acid dihydrazide, maleic acid dihydrazide, itaconic acid dihydrazide, trimellitic acid dihydrazide, 1,3,5-benzenetricarboxylic acid dihydrazide, aconitic acid dihydrazide, and pyromellitic acid dihydrazide. Preferred is adipic acid dihydrazide.

Examples of the amine-based crosslinking agent include: aliphatic polyamines such as hexamethylenediamine, 1,12-dodecanediamine, hexamethylenediamine carbamate, N,N-dicinnamylidene-1,6-hexanediamine, tetramethylene pentamine, and a hexamethylene diamine cinnamaldehyde adduct; aromatic multivalent amines such as 4,4-methylenedianiline, m-phenylenediamine, 4,4-diaminodiphenyl ether, 3,4-diaminodiphenyl ether, 4,4-(m-phenylenediisopropylidene)dianyline, 4,4-(p-phenylenediisopropylidene)dianyline, 2,2-bis[4-(4-aminophenoxy)phenyl)]propane, 4,4-diaminobenzanilide, 4,4-bis(4-aminophenoxy)biphenyl, m-xylylenediamine, p-xylylenediamine, and 1,3,5-benzenetriamine; and diamines each having polyether in its main chain, such as polyethylene glycol diamine, polypropylene glycol diamine, and diethylene glycol bis(3-aminopropyl) ether. Preferred is diethylene glycol bis(3-aminopropyl) ether.

Examples of the isocyanate-based crosslinking agent include: aliphatic polyisocyanate such as 1, 6-hexamethylene diisocyanate, 1,4-tetramethylene diisocyanate, 2-methyl-1,5-pentane diisocyanate, 3-methyl-1,5-pentane diisocyanate, or lysine diisocyanate; alicyclic polyisocyanate such as isophorone diisocyanate, cyclohexyl diisocyanate, hydrogenated tolylene diisocyanate, hydrogenated xylene diisocyanate, hydrogenated diphenylmethane diisocyanate, or hydrogenated tetramethylxylene diisocyanate; aromatic polyisocyanate such as 2,4-tolylene diisocyanate, 2, 6-tolylene diisocyanate, 4,4′-diphenylmethane diisocyanate, 2,4′-diphenylmethane diisocyanate, 4,4′-diphenyl ether diisocyanate, 2-nitrodiphenyl-4,4′-diisocyanate, 2,2′-diphenylpropane-4,4′-diisocyanate, 3,3′-dimethyldiphenylmethane-4,4′-diisocyanate, 4,4′-diphenylpropane diisocyanate, m-phenylene diisocyanate, p-phenylene diisocyanate, naphthylene-1,4-diisocyanate, naphthylene-1,5-diisocyanate, 3,3′-dimethoxydiphenyl-4,4′-diisocyanate, xylylene-1,4-diisocyanate, or xylylene-1,3-diisocyanate.

As the isocyanate-based crosslinking agent, there also can be used dimers and trimers of the above-mentioned isocyanate-based compounds, and a product obtained by a reaction between or polymerization of the above-mentioned isocyanate-based compounds (such as a dimer and a trimer of diphenylmethane diisocyanate, a product obtained by a reaction between trimethylolpropane and tolylene diisocyanate, a product obtained by a reaction between trimethylolpropane and hexamethylene diisocyanate, polymethylene polyphenyl isocyanate, polyether polyisocyanate, and polyester polyisocyanate). As the isocyanate-based crosslinking agent, a product obtained by a reaction between trimethylolpropane and tolylene diisocyanate is preferred.

Examples of the epoxy-based crosslinking agent include an epoxy-based compound having two or more, or three or more epoxy groups in one molecule thereof, such as 1,3-bis(N,N-diglycidylaminomethyl)cyclohexane, N,N,N′,N′-tetraglycidyl-m-xylenediamine, diglycidyl aniline, 1,6-hexanediol diglycidyl ether, neopentyl glycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol polyglycidyl ether, pentaerythritol polyglycidyl ether, polyglycerol polyglycidyl ether, sorbitan polyglycidyl ether, trimethylolpropane polyglycidyl ether, adipic acid diglycidyl ester, o-phthalic acid diglycidyl ester, triglycidyl-tris(2-hydroxyethyl) isocyanurate, resorcinol diglycidyl ether, bisphenol S diglycidyl ether, 1,3-bis(N,N-diglycidyl aminomethyl) benzene, 1,3-bis(N,N-diglycidyl aminomethyl) toluene, 1,3,5-triglycidyl isocyanurate, N,N,N′,N′-tetraglycidyl-m-xylylenediamine, glycerol triglycidyl ether, or trimethylolpropane glycidyl ether. Preferred is 1,3-bis(N,N-diglycidylaminomethyl)cyclohexane.

The polymer B may be a (meth)acrylic polymer that does not have a crosslinked structure. For example, the polymer B may include, as a main component, a structural unit derived from alkyl (meth)acrylate such as methyl (meth)acrylate or n-butyl (meth)acrylate, and may be composed substantially of the structural unit alone. The polymer B may have the composition and structure mentioned above for the prepolymer.

A weight-average molecular weight of the polymer B is, for example, 5000 or more, preferably 10000 or more, more preferably 20000 or more, and still more preferably 40000 or more. The upper limit of the weight-average molecular weight of the polymer B is, for example, but not particularly limited to, 5000000, preferably 2000000, and more preferably 1500000. The weight-average molecular weight of the polymer B can be specified by the method mentioned above for the polymer A.

The content of the polymer B in the separation functional layer 1 is, for example, but not particularly limited to, 1 wt % or more, and may be 5 wt % or more, 10 wt % or more, or even 15 wt % or more. The higher the content of the polymer B is, the more enhanced acid gas permeation performance the separation functional layer 1 tends to have. The upper limit of the content of the polymer B is, for example, but not particularly limited to, 30 wt % or less, and may be 20 wt % or less. The separation functional layer 1 does not need to include the polymer B in some cases.

In the separation functional layer 1, the weight ratio (A/B) of the polymer A with respect to the polymer B is, for example, but not particularly limited to, 20/80 to 80/20, and may be 40/60 to 80/20, or even 60/40 to 80/20.

### (Additional Component)

The separation functional layer 1 may further include an additional component other than the ionic liquid L, the polymer A, and the polymer B. Examples of the additional component include a surfactant.

### (Method for Manufacturing Separation Functional Layer)

The method for manufacturing the separation functional layer 1 includes, for example, at least one selected from the group consisting of step (i) and step (ii) below.
Step (i): drying a mixed solution M1 containing the ionic liquid L, the polymer A, and the polymer B.
Step (ii): allowing, in a mixed solution M2 containing the ionic liquid L, the polymer A, the prepolymer, and the crosslinking agent, the prepolymer to react with the crosslinking agent in such a manner that the polymer B is formed.

First, a manufacturing method including the step (i) will be explained. The manufacturing method including the step (i) is suitable for producing the separation functional layer 1 including the polymer B that does not have a chemically crosslinked structure.

The mixed solution M1 further includes, for example, a solvent such as water. The concentration of nonvolatile substances (the ionic liquid L, the polymer A, and the polymer B) in the mixed solution M1 is, for example, but not particularly limited to, 10 wt % to 90 wt %, and may be 20 wt % to 50 wt %.

In a preferred embodiment of the present invention, a coating film produced by applying the mixed solution M1 onto a substrate is dried to produce the separation functional layer 1. Typically, the substrate is a release liner. Examples of the release liner include: a film including a resin; paper; and a sheet including a metal material such as aluminum or stainless steel. The sheet including a metal material tends to have high heat resistance. The release liner is preferably a film including a resin from the viewpoint of having excellent surface smoothness. Examples of a polymer included in the resin in the release liner include: polyolefin such as polyethylene, polypropylene, polybutene, polybutadiene, or polymethylpentene; polyester such as polyethylene terephthalate, polybutylene terephthalate, or polyethylene naphthalate; polyvinyl chloride and a vinyl chloride copolymer; polyurethane; and an ethylene-vinyl acetate copolymer. Polyester, particularly polyethylene terephthalate, is preferred.

A surface of the release liner may be subjected to a release treatment. The release treatment can be provided by, for example, applying a release treatment agent onto the surface of the release liner. Examples of the release treatment agent include a silicone-based release treatment agent, a long-chain alkyl-based release treatment agent, a fluorine-based release treatment agent, and a molybdenum sulfide-based release treatment agent. One of these release treatment agents may be used alone or two or more of them can be used in combination. The release liner is preferably a polyethylene terephthalate (PET) film subjected to the release treatment.

The thickness of the release liner is, for example, but not particularly limited to, 5 to 100 μm, and preferably 10 to 50 μm.

The method for applying the mixed solution M1 onto the substrate is not particularly limited, and a method such as a spin coating method or a dip coating method can be used, for example. The mixed solution M1 may be applied onto the substrate using an applicator, a wire bar, or the like. A coating film is formed by applying the mixed solution M1 onto the substrate.

In another preferred embodiment of the present invention, the mixed solution M1 is put in a mold and then the mixed solution M1 is dried to produce the separation functional layer 1. The mold is typically a laboratory dish made from PTFE.

The drying treatment of the mixed solution M1 (specifically, the coating film produced by applying the mixed solution M1 onto the substrate, or the mixed solution M1 put in the mold) can be carried out, for example, by leaving the mixed solution M1 at a room temperature. However, the mixed solution M1 may be dried by being heated. The duration of the drying treatment is, for example, 1 hour or longer, and may be 5 hours or longer. By peeling off the separation functional layer 1 from the substrate or the mold, the separation functional layer 1 that functions as a self-supporting membrane can be obtained.

Next, a manufacturing method including the step (ii) will be explained. The manufacturing method including the step (ii) makes it possible to obtain the separation functional layer 1 including the polymer B having a chemically crosslinked structure.

The mixed solution M2 has the same composition as that of the mixed solution M1 mentioned above, except that the mixed solution M2 includes the prepolymer and the crosslinking agent instead of the polymer B. In one example, it is possible to produce the separation functional layer 1 by applying the mixed solution M2 onto a substrate and then allowing the prepolymer to react with the crosslinking agent, or by putting the mixed solution M2 in a mold and then allowing the prepolymer to react with the crosslinking agent. As the substrate and the mold, those mentioned above can be used.

It is possible to allow the reaction between the prepolymer and the crosslinking agent to proceed by, for example, heat-treating the mixed solution M2 (specifically, a coating film produced by applying the mixed solution M2 onto the substrate, or the mixed solution M2 put in the mold). The temperature of the heat treatment is, for example, but not particularly limited to, 30° C. or higher, and may be 50° C. to 110° C. The duration of the heat treatment is, for example, 1 minute or longer, and may be 5 minutes or longer. When the reaction between the prepolymer and the crosslinking agent proceeds, the polymer B having a crosslinked structure is formed. Thereby, the separation functional layer 1 including the ionic liquid L, the polymer A, and the polymer B is formed.

(Physical Properties, Etc. Of Separation Functional Layer)

The thickness of the separation functional layer 1 is, for example, 500 μm or less, and preferably 300 μm or less, and may be 100 μm or less, 50 μm or less, 25 μm or less, 15 μm or less, 10 μm or less, 5.0 μm or less, or 2.0 μm or less. The thickness of the separation functional layer 1 may be 0.05 μm or more, or 0.1 μm or more.

The separation functional layer 1 tends to have a high mechanical strength because of the polymer A. In one example, when the separation functional layer 1 is subjected to a tensile test, the breaking strength of the separation functional layer 1 is, for example, 100 kPa or more, preferably 300 kPa or more, 500 kPa or more, 1000 kPa or more, 1500 kPa or more, 2000 kPa or more, 2500 kPa or more, and more preferably 3000 kPa or more. The upper limit of the breaking strength of the separation functional layer 1 is, for example, but not particularly limited to, 10000 kPa or less. The tensile test on the separation functional layer 1 can be conducted in accordance with the regulation of JIS K7161-1:2014. In the present description, the breaking strength refers to a tensile fracture stress 6b specified in JIS K7161-1:2014.

Leakage of the ionic liquid L from the separation functional layer 1 also tends to be suppressed. In one example, the ratio (leakage rate) of the weight of the ionic liquid L that leaks from the separation functional layer 1 when the separation functional layer 1 is subjected to a compression test with respect to the weight of the ionic liquid L included in the separation functional layer 1 is, for example, 5.0 wt % or less, and may be 3.0 wt % or less, or even 2.0 wt % or less. In the compression test, the ionic liquid L may not substantially leak from the separation functional layer 1. Here, the compression test is conducted by applying a compressive load of 1.16 MPa to the separation functional layer 1 for 2 minutes. The direction in which the compressive load is applied is aligned with a thickness direction of the separation functional layer 1. The compression test is conducted under the condition of the room temperature (25° C.).

As described above, the separation functional layer 1 allows an acid gas contained in a gas mixture to preferentially permeate therethrough. In one example, a permeance T1 of carbon dioxide permeating through the separation functional layer 1 is, for example, 0.1 GPU or more, and may be 0.3 GPU or more, 0.4 GPU or more, 0.5 GPU or more, 0.6 GPU or more, 0.7 GPU or more, 0.8 GPU or more, 0.9 GPU or more, or even 1.0 GPU or more. The upper limit of the permeance T1 is, for example, but not particularly limited to, 1000 GPU or less, and may be 100 GPU or less, or 10 GPU or less in some cases. Note that GPU means 10⁻⁶·cm³(STP)/(sec·cm²·cmHg).

Furthermore, a permeability C1 of carbon dioxide permeating through the separation functional layer 1 is, for example, 100 Barrer or more, preferably 150 Barrer or more, 170 Barrer or more, 200 Barrer or more, 230 Barrer or more, 250 Barrer or more, 270 Barrer or more, and more preferably 300 Barrer or more. The upper limit of the permeability C1 is, for example, but not particularly limited to, 1000 Barrer. Here, Barrer means 10⁻¹⁰·cm³(STP)/(sec·cm²·cmHg). The symbol “cm³(STP)” means the volume of carbon dioxide at 1 atmospheric pressure and 0° C. The permeability C1 (Barrer) is a value obtained by multiplying the permeance T1 (GPU) by the thickness (μm) of the separation functional layer 1.

The permeance T1 and the permeability C1 can be calculated by the following method. First, a gas mixture composed of carbon dioxide and hydrogen is supplied to a space adjacent to one surface of the separation functional layer 1 while a space adjacent to another surface of the separation functional layer 1 is decompressed. Thereby, a permeated fluid that has permeated through the separation functional layer 1 can be obtained. The weight of the permeated fluid and the volume rate of carbon dioxide and the volume rate of hydrogen in the permeated fluid are measured. The permeance T1 and the permeability C1 can be calculated from the measurement results. In the above operation, the concentration of the carbon dioxide in the gas mixture is 50 vol % under a standard condition (0° C., 101 kPa). The gas mixture supplied to the space adjacent to the one surface of the separation functional layer 1 has a temperature of 30° C. and a pressure of 0.1 MPa. The space adjacent to the other surface of the separation functional layer 1 is decompressed in such a manner that a pressure in the space adjacent to the other surface is lower than an atmospheric pressure in a measurement environment by 0.1 MPa.

Under the above measurement conditions for the permeance T1 and the permeability C1, a separation factor α1 of the separation functional layer 1 for carbon dioxide with respect to hydrogen is, for example, but not particularly limited to, 5 or more, preferably 6 or more, 7 or more, 8 or more, 9 or more, and more preferably 10 or more. The upper limit of the separation factor α1 is, for example, but not particularly limited to, 50 or less. The separation factor α1 can be calculated by the following formula. It should be noted that, in the following formula, X_{A} and X_{B} are respectively the volume rate of the carbon dioxide and the volume rate of the hydrogen in the gas mixture. YA and YB are respectively the volume rate of the carbon dioxide and the volume rate of the hydrogen in the permeated fluid that has permeated through the separation functional layer 1.

$$Separation factor α 1 = ( {Y}_{A} / {Y}_{B} ) / ( {X}_{A} / {X}_{B} )$$

### (Use of Separation Functional Layer)

As a use of the separation functional layer 1 of the present embodiment, there can be mentioned the use for separating an acid gas from a gas mixture containing the acid gas. Examples of the acid gas in the gas mixture include carbon dioxide, hydrogen sulfide, carbonyl sulfide, sulfur oxide (SOx), hydrogen cyanide, and nitrogen oxide (NOx), and preferred is carbon dioxide. The gas mixture contains an additional gas other than the acid gas. Examples of the additional gas include a nonpolar gas such as hydrogen or nitrogen, and an inert gas such as helium, and preferred is hydrogen. Particularly, the separation functional layer 1 of the present embodiment is suitably used for separating carbon dioxide from a gas mixture containing carbon dioxide and hydrogen. However, the use of the separation functional layer 1 is not limited to the use for separating an acid gas from the above-mentioned gas mixture.

### <Embodiment of Separation Membrane>

As shown in FIG. 2, a separation membrane 10 of the present embodiment includes the above-mentioned separation functional layer 1, and further includes, for example, a porous support member 3. The porous support member 3 supports the separation functional layer 1. The separation membrane 10 may further include an intermediate layer 2 disposed between the separation functional layer 1 and the porous support member 3. The intermediate layer 2 is, for example, in direct contact with each of the separation functional layer 1 and the porous support member 3.

The separation functional layer 1 included in the separation membrane 10 does not need to include the polymer B in some cases.

In another aspect, the present invention provides the separation membrane 10 including:
the separation functional layer 1; and
the porous support member 3 supporting the separation functional layer 1, wherein
the separation functional layer 1 includes the ionic liquid L, and the polymer A that is hydrophilic and forms a crystal structure in the ionic liquid L.

### (Intermediate Layer)

The intermediate layer 2 includes, for example, a resin, and further includes nanoparticles dispersed in the resin (matrix). The nanoparticles may be spaced from each other in the matrix, or may aggregate partially. However, the intermediate layer 2 does not need to include the nanoparticles, and may be composed substantially of the resin.

A material of the matrix is not particularly limited, and examples thereof include a silicone resin such as polydimethylsiloxane; a fluorine resin such as polytetrafluoroethylene; an epoxy resin such as polyethylene oxide; a polyimide resin; a polysulfone resin; a polyacetylene resin such as polytrimethylsilylpropyne and polydiphenylacetylene; and a polyolefin resin such as polymethylpentene. The matrix preferably includes a silicone resin.

Each nanoparticle may include an inorganic material. The nanoparticle may include an organic material. The inorganic material included in the nanoparticle is, for example, silica, titania, or alumina. The nanoparticle preferably includes silica.

The nanoparticle may have a surface modified with a modifying group including a carbon atom. The nanoparticle having the surface modified with the modifying group exhibits an excellent dispersibility in the matrix. The nanoparticle is, for example, a silica nanoparticle that may have a surface modified with a modifying group. The modifying group further includes a silicon atom, for example. The surface of the nanoparticle is represented, for example, by the following formulae (I) to (III), the surface being modified with the modifying group.

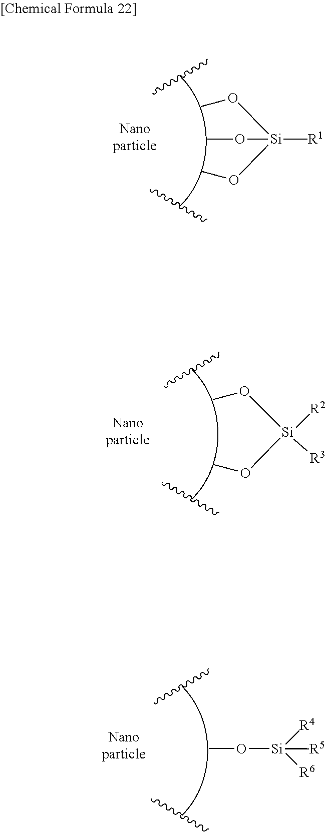

R⁶ to R¹¹ in the formulae (I) to (III) are each independently an optionally substituted hydrocarbon group. The number of carbon atoms in the hydrocarbon group is not particularly limited as long as it is one or more. The number of carbon atoms in the hydrocarbon group may be, for example, 25 or less, 20 or less, 10 or less, or 5 or less. In some cases, the number of carbon atoms in the hydrocarbon group may be more than 25. The hydrocarbon group may be a linear or branched chain hydrocarbon group, or may be an alicyclic or aromatic cyclic hydrocarbon group. In a preferred embodiment, the hydrocarbon group is a linear or branched alkyl group having 1 to 8 carbon atoms. The hydrocarbon group is, for example, a methyl group or an octyl group, and is preferably a methyl group. Examples of the substituent in the hydrocarbon group include an amino group and an acyloxy group. Examples of the acyloxy group include a (meth)acryloyloxy group.

In another preferred embodiment, the above optionally substituted hydrocarbon group represented by R⁶ to R¹¹ in the formulae (I) to (III) is represented by the following formula (IV). The nanoparticle having a surface modified with a modifying group including the hydrocarbon group represented by the formula (IV) is suitable for improving a permeance of an acid gas permeating through the separation membrane 10.

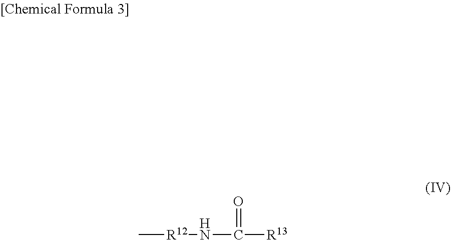

In the formula (IV), R¹² is an optionally substituted alkylene group having 1 to 5 carbon atoms. The alkylene group may be linear or branched. Examples of the alkylene group include a methylene group, an ethylene group, a propane-1,3-diyl group, a butane-1,4-diyl group, and a pentane-1,5-diyl group, and preferred is a propane-1,3-diyl group. Examples of the substituent in the alkylene group include an amide group and an aminoalkylene group.

In the formula (IV), R¹³ is an optionally substituted alkyl group or aryl group having 1 to 20 carbon atoms. The alkyl group may be linear or branched. Examples of the alkyl group and the aryl group include those described above for the ionic liquid L. Examples of the substituents in the alkyl group and the aryl group include an amino group and a carboxyl group. R¹³ is, for example, a 3,5-diaminophenyl group.

The surface of the nanoparticle is preferably represented by the following formula (V), the surface being modified with the modifying group.

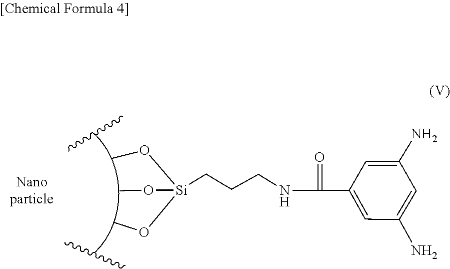

The modifying group is not limited to have the structures shown in the formulae (I) to (III). The modifying group may include a polymer chain having a polyamide structure or a polydimethylsiloxane structure instead of R⁶ to R¹¹ in the formulae (I) to (III). In the modifying group, for example, this polymer chain is directly bonded to a silicon atom. Examples of the shape of this polymer chain include linear, dendritic, and hyper-branched shapes.

The method for modifying the surface of the nanoparticle with the modifying group is not particularly limited. For example, the surface of the nanoparticle can be modified by allowing a hydroxyl group present on the surface of the nanoparticle to react with a known silane coupling agent. In the case where the modifying group includes a polyamide structure, the surface of the nanoparticle can be modified by, for example, the method disclosed in JP 2010-222228 A.

The average particle size of the nanoparticles is not particularly limited as long as it is on the order of nanometers (<1000 nm). The average particle size of the nanoparticles is, for example, 100 nm or less, preferably 50 nm or less, and more preferably 20 nm or less. The lower limit of the average particle size of the nanoparticles is, for example, 1 nm. The average particle size of the nanoparticles can be specified by the following method, for example. First, a cross section of the intermediate layer 2 is observed with a transmission electron microscope. In the obtained electron microscope image, the area of a specific nanoparticle is calculated by image processing. The diameter of a circle having the same area as the calculated area is regarded as the particle size (the diameter of the particle) of the specific nanoparticle. The particle size is calculated for any number (at least 50) of the nanoparticles, and the average of the calculated values is regarded as the average particle size of the nanoparticles. The shape of each nanoparticle is not particularly limited, and may be a spherical, ellipsoidal, flaky, or fibrous shape.

The content of the nanoparticles in the intermediate layer 2 is, for example, 5 wt % or more, preferably 10 wt % or more, and more preferably 15 wt % or more. The upper limit of the content of the nanoparticles in the intermediate layer 2 is, for example, but not particularly limited to, 30 wt %.

The thickness of the intermediate layer 2 is, for example, but not particularly limited to, less than 50 μm, preferably 40 μm or less, and more preferably 30 μm or less. The lower limit of the thickness of the intermediate layer 2 is, for example, but not particularly limited to, 1 μm. The intermediate layer 2 is, for example, a layer having a thickness of less than 50 μm.

### (Porous Support Member)

The porous support member 3 supports the separation functional layer 1 via the intermediate layer 2. Examples of the porous support member 3 include: a nonwoven fabric; porous polytetrafluoroethylene; an aromatic polyamide fiber; a porous metal; a sintered metal; a porous ceramic; a porous polyester; porous nylon; an activated carbon fiber; latex; silicone; silicone rubber; a permeable (porous) polymer including at least one selected from the group consisting of polyvinyl fluoride, polyvinylidene fluoride, polyurethane, polypropylene, polyethylene, polystyrene, polycarbonate, polysulfone, polyether ether ketone, polyacrylonitrile, polyimide, and polyphenylene oxide; a metallic foam having an open cell or a closed cell; a polymer foam having an open cell or a closed cell; silica; a porous glass; and a mesh screen. The porous support member 3 may be a combination of two or more of these materials.

The porous support member 3 has, for example, an average pore diameter of 0.01 to 0.4 μm. The thickness of the porous support member 3 is, for example, but not particularly limited to, 10 μm or more, preferably 20 μm or more, and more preferably 50 μm or more. The thickness of the porous support member 3 is, for example, 300 μm or less, preferably 200 μm or less, and more preferably 150 μm or less.

### (Method for Producing Separation Membrane)

The separation membrane 10 can be produced by the following method, for example. First, a laminate of the porous support member 3 and the intermediate layer 2 is prepared. This laminate can be produced by the following method, for example. First, a coating liquid containing the materials of the intermediate layer 2 is prepared. Next, the coating liquid containing the materials of the intermediate layer 2 is applied onto the porous support member 3 to form a coating film. The method for applying the coating liquid is not particularly limited, and a method such as spin coating method or a dip coating method can be used, for example. The coating liquid may be applied, for example, using a wire bar. Next, the coating film is dried to form the intermediate layer 2. The coating film can be dried under heating conditions, for example. The heating temperature of the coating film is, for example, 50° C. or higher. The heating duration of the coating film is, for example, one minute or longer, and may be five minutes or longer. Furthermore, the surface of the intermediate layer 2 may be subjected to an adhesion improvement treatment, if necessary. The adhesion improvement treatment is, for example, a surface treatment such as application of a primer, a corona discharge treatment, or a plasma treatment.

Next, the mixed solution M1 (or the mixed solution M2) for forming the separation functional layer 1 is applied onto the intermediate layer 2 in the laminate of the porous support member 3 and the intermediate layer 2. The obtained coating film is dried to form the separation functional layer 1 on the intermediate layer 2, and thus the separation membrane 10 can be obtained. In the present embodiment, the separation functional layer 1 has an enhanced strength. Therefore, it is also possible to form the separation functional layer 1 on the intermediate layer 2 by a roll-to-roll method.

The method for producing the separation membrane 10 is not limited to the above-mentioned method. For example, the separation membrane 10 may be produced by the following method. First, the separation functional layer 1 formed on the substrate, such as a release liner, is prepared by the above-mentioned method. Next, the coating liquid containing the materials of the intermediate layer 2 is applied onto the separation functional layer 1, and the applied coating liquid is dried to form the intermediate layer 2. The laminate of the intermediate layer 2 and the separation functional layer 1 is transferred to the porous support member 3. Thereby, the separation membrane 10 can be obtained.

### (Shape of Separation Membrane)

In the present embodiment, the separation membrane 10 is typically a flat membrane. However, the separation membrane 10 may have a shape other than that of a flat membrane, and may be a hollow fiber membrane, for example. In one example, the separation membrane 10 as a hollow fiber membrane does not need to include the intermediate layer 2 while including the separation functional layer 1 and the porous support member 3.

### (Characteristics of Separation Membrane)

The separation membrane 10 of the present embodiment allows an acid gas contained in a gas mixture to preferentially permeate therethrough by having the separation functional layer 1. In one example, a permeance T2 of the carbon dioxide permeating through the separation membrane 10 is, for example, 50 GPU or more, and may be 80 GPU or more, 100 GPU or more, 120 GPU or more, 150 GPU or more, or even 180 GPU or more. The upper limit of the permeance T2 is, for example, but not particularly limited to, 1000 GPU or less.

The permeance T2 can be calculated by the method mentioned above for the permeance T1 and the permeability C1 of the separation functional layer 1. Here, the gas mixture composed of carbon dioxide and hydrogen is supplied to, for example, a space adjacent to a main surface 11, on the separation functional layer side, of the separation membrane 10. Furthermore, a space adjacent to a main surface 12, on the porous support member side, of the separation membrane 10 is decompressed.

Under the measurement conditions for the permeance T2, a separation factor α2 of the separation membrane 10 for carbon dioxide with respect to hydrogen is, for example, but not particularly limited to, 5 or more, preferably 6 or more, 7 or more, 8 or more, 9 or more, and more preferably 10 or more. The upper limit of the separation factor α2 is, for example, but not particularly limited to, 50 or less. The separation factor α2 can be calculated by the method mentioned above for the separation factor α1.

### <Embodiment of Membrane Separation Device>

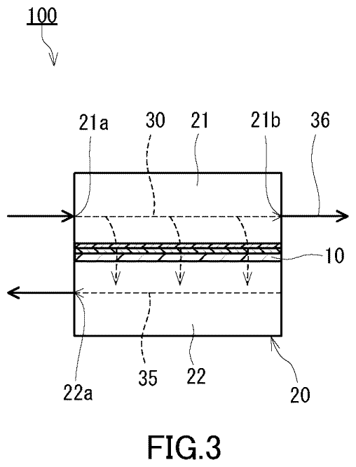

As shown in FIG. 3, a membrane separation device 100 of the present embodiment includes the separation membrane 10 and a tank 20. In the membrane separation device 100, it is also possible to use the separation functional layer 1 alone instead of the separation membrane 10. The tank 20 includes a first chamber 21 and a second chamber 22. The separation membrane 10 is disposed in the tank 20. In the tank 20, the separation membrane 10 separates the first chamber 21 and the second chamber 22 from each other. The separation membrane 10 extends from one of a pair of wall surfaces of the tank 20 to the other.

The first chamber 21 has an inlet 21a and an outlet 21b. The second chamber 22 has an outlet 22a. The inlet 21a, the outlet 21b, and the outlet 22a are each, for example, an opening provided in a wall surface of the tank 20.

Membrane separation using the membrane separation device 100 is performed by the following method, for example. First, a gas mixture 30 containing an acid gas is supplied to the first chamber 21 via the inlet 21a. The concentration of the acid gas in the gas mixture 30 is, for example, but not particularly limited to, 0.01 vol % (100 ppm) or more, preferably 1 vol % or more, more preferably 10 vol % or more, still more preferably 30 vol % or more, and particularly preferably 50 vol % or more, under the standard condition. The upper limit of the concentration of the acid gas in the gas mixture 30 is, for example, but not particularly limited to, 90 vol % under the standard condition.

The pressure in the first chamber 21 may be increased by supplying the gas mixture 30. The membrane separation device 100 may further include a pump (not shown) for increasing the pressure of the gas mixture 30. The pressure of the gas mixture 30 to be supplied to the first chamber 21 is, for example, 0.1 MPa or more, and preferably 0.3 MPa or more.

The pressure in the second chamber 22 may be decreased while the gas mixture 30 is supplied to the first chamber 21. The membrane separation device 100 may further include a pump (not shown) for decreasing the pressure in the second chamber 22. The pressure in the second chamber 22 may be decreased such that a space in the second chamber 22 has a pressure lower than an atmospheric pressure in a measurement environment by, for example, 10 kPa or more, preferably 50 kPa or more, and more preferably 100 kPa or more.

Supply of the gas mixture 30 to the first chamber 21 allows to obtain, on the other surface side of the separation membrane 10, a permeated fluid 35 in which the acid gas content is higher than in the gas mixture 30. That is, the permeated fluid 35 is supplied to the second chamber 22. The permeated fluid 35 contains, for example, the acid gas as a main component. The permeated fluid 35 may contain a small amount of a gas other than the acid gas. The permeated fluid 35 is discharged outside the tank 20 via the outlet 22a.

The concentration of the acid gas in the gas mixture 30 gradually decreases from the inlet 21a toward the outlet 21b in the first chamber 21. The gas mixture 30 processed in the first chamber 21 (a non-permeated fluid 36) is discharged outside the tank 20 via the outlet 21b.

The membrane separation device 100 of the present embodiment is suitable for flow (continuous) membrane separation. The membrane separation device 100 of the present embodiment may be used for batch membrane separation.

### <Modification of Membrane Separation Device>

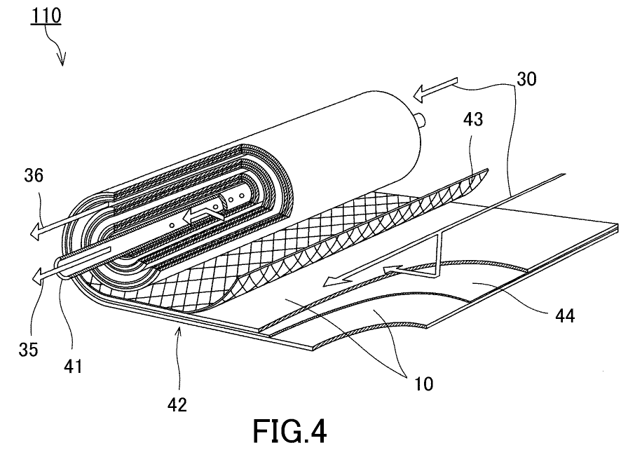

The membrane separation device 100 may be a spiral membrane element, a hollow fiber membrane element, or the like. FIG. 4 shows a spiral membrane element.

A membrane separation device 110 of FIG. 4 includes a central tube 41 and a laminate 42. The laminate 42 includes the separation membrane 10. The laminate 42 may include the separation functional layer 1 alone instead of the separation membrane 10.

The central tube 41 has a cylindrical shape. The central tube 41 has, in its surface, a plurality of holes for allowing the permeated fluid 35 to flow into the central tube 41. Examples of a material of the central tube 41 include: a resin such as an acrylonitrile-butadiene-styrene copolymer resin (ABS resin), a polyphenylene ether resin (PPE resin), or a polysulfone resin (PSF resin); and a metal such as stainless steel or titanium. The central tube 41 has an inner diameter in the range of 20 to 100 mm, for example.

The laminate 42 further includes a feed-side flow passage material 43 and a permeation-side flow passage material 44 in addition to the separation membrane 10. The laminate 42 is wound around the central tube 41. The membrane separation device 110 may further include an exterior material (not shown).

For example, a resin net composed of polyphenylene sulfide (PPS) or an ethylene-chlorotrifluoroethylene copolymer (ECTFE) can be used as the feed-side flow passage material 43 and the permeation-side flow passage material 44.

In the membrane separation device 110, a stress is applied to the separation membrane 10 that is in contact with the feed-side flow passage material 43 and the permeation-side flow passage material 44. As described above, the separation functional layer 1 tends to have a high strength in the separation membrane 10, and thus the above-mentioned stress hardly deteriorates the characteristics of the separation membrane 10. In one example, the separation factor α2 of the separation membrane 10 tends to be hardly lowered when compared before and after the production of the membrane separation device 110.

Membrane separation using the membrane separation device 110 is performed by the following method, for example. First, the gas mixture 30 is supplied into one end of the wound laminate 42. The permeated fluid 35 that has permeated through the separation membrane 10 of the laminate 42 moves into the central tube 41. The permeated fluid 35 is discharged outside via the center tube 41. The gas mixture 30 processed by the membrane separation device 110 (the non-permeated fluid 36) is discharged outside from another end of the wound laminate 42. Thus, the acid gas can be separated from the gas mixture 30.

### EXAMPLES

Hereinafter, the present invention will be described in more detail by way of Examples and Comparative Examples, but the present invention is not limited to these examples.

### Example A1

First, 4 g of polyvinyl alcohol (PVA, available from Sigma Aldrich, weight-average molecular weight 85000 to 124000, saponification degree 87 to 89 mol %) as the polymer A was added to 36 g of water and the resultant was heated to 90° C. The resultant was stirred until the PVA completely dissolved to prepare a PVA aqueous solution. Next, 1.6 g of polyvinylpyrrolidone (PVP, available from Sigma Aldrich, weight-average molecular weight 360000) as the polymer B was added to 38.4 g of water. The resultant was stirred at 25° C. until the PVP dissolved completely to prepare a PVP aqueous solution.

Next, 1.5 g of the PVA aqueous solution, 1.5 g of the PVP aqueous solution, and 0.63 g of 1-ethyl-3-methylimidazolium dicyanamide ([EMIM][DCA]) as the ionic liquid L were mixed and stirred well until they dissolved completely. Thus, a mixed solution was obtained.

Next, the obtained mixed solution was placed in a mold (a laboratory dish) made from PTFE and dried in a constant temperature bath at 30° C. for 48 hours, and further dried on a hot plate at 70° C. for 3 hours. Thus, a separation functional layer (self-supporting membrane) of Example A1 was obtained.

### Examples A2 and A3

A separation functional layer (self-supporting membrane) of each of Examples A2 and A3 was obtained in the same manner as in Example A1, except that the weight ratio of the ionic liquid L with respect to the polymers A and B was changed as shown in Table 1.

### Example A4

A separation functional layer (self-supporting membrane) of Example A4 was obtained in the same manner as in Example A1, except that the polymer B was not used and the weight ratio of the ionic liquid L with respect to the polymer A was 75/25.

### Example A5

It was tried to produce a separation functional layer (self-supporting membrane) of Example A5 in the same manner as in Example A1, except that the polymer A was not used and the weight ratio of the ionic liquid L with respect to the polymer B was 75/25. However, the mixed solution failed to be sufficiently solidified and it was impossible to obtain the separation functional layer.

### [Compression Test]

The separation functional layer of each of Examples A1 to A4 was subjected to a compression test in the same manner as mentioned above. Here, the ratio (leakage rate) of the weight of the ionic liquid that leaked from the separation functional layer when the separation functional layer was subjected to the compression test with respect to the weight of the ionic liquid L included in the separation functional layer was specified. Table 1 shows the results.

### [Tensile Test]

The separation functional layer of each of Examples A1 to A4 was subjected to a tensile test in the same manner as mentioned above and measured for breaking strength. Table 1 shows the results.

### [Gas Permeation Test]

The separation functional layer of each of Examples A1 to A4 was measured for the permeance T1 of carbon dioxide and the permeability C1 of carbon dioxide, and the separation factor α1 (CO₂/H₂) of the separation functional layer for carbon dioxide with respect to hydrogen was measured, by the method below using a differential pressure-type gas permeation testing device (GTR-31AHND available from GTR TEC Corporation). First, each separation functional layer cut into an approximately 3 cm square was placed in a metal cell, and the metal cell was sealed with an O-ring so that no leakage would occur. Next, a gas mixture was injected into the metal cell so that the gas mixture would come into contact with one main surface of the separation functional layer. The gas mixture was composed substantially of carbon dioxide and hydrogen. The concentration of carbon dioxide in the gas mixture was 50 vol % under the standard condition. The gas mixture injected into the metal cell had a temperature of 30° C. and a pressure of 0.1 MPa. Next, a space adjacent to another main surface of the separation functional layer was decompressed using a vacuum pump. This space was decompressed in such a manner that a pressure in the space was lower than an atmospheric pressure in a measurement environment by 0.1 kPa. Accordingly, a permeated fluid was obtained from the other main surface of the separation functional layer. The permeance T1, the permeability C1, and the separation factor α1 were calculated based on the composition of the obtained permeated fluid, the weight of the permeated fluid, etc. Table 1 shows the results.

TABLE 1

| | | Example | Example | Example | Example | Example |
|---|---|---|---|---|---|---|
| | | A1 | A2 | A3 | A4 | A5 |
| Polymer A | | PVA | PVA | PVA | PVA | — |
| Polymer B | | PVP | PVP | PVP | — | PVP |
| Ionic liquid | | [EMIM] | [EMIM] | [EMIM] | [EMIM] | [EMIM] |
| | | [DCA] | [DCA] | [DCA] | [DCA] | [DCA] |
| Weight ratio | | 75/25 | 85/15 | 65/35 | 75/25 | 75/25 |
| (Ionic liquid/Polymer(s)) | | | | | | |
| Weight ratio | | 71/29 | 71/29 | 71/29 | 100/0 | 0/100 |
| (Polymer A/Polymer B) | | | | | | |
| Self- | Leakage rate | 1.7 | 3.8 | 0 | 2.1 | — |
| supporting | (wt %) | | | | | |
| membrane | Breaking strength | 1640 | 358 | 3147 | 2376 | — |
| | (kPa) | | | | | |
| | Thickness (μm) | 432 | 490 | 300 | 450 | — |
| | CO₂ permeance T1 | 0.60 | 0.99 | 0.57 | 0.37 | — |
| | (GPU) | | | | | |
| | CO₂ permeability | 259 | 486 | 171 | 167 | — |
| | C1 (Barrer) | | | | | |
| | CO₂/H₂ separation | 11.3 | 15.2 | 8.4 | 7.7 | — |
| | factor α1 (—) | | | | | |

As understood from Table 1, the separation functional layers of Examples A1 to A3 including the polymer A and the polymer B exhibited more excellent carbon dioxide permeation performance than that of Example A4.

### Example B11

First, an ultrafiltration membrane (NTU-3175M available from Nitto Denko Corporation) as the porous support member was prepared. Next, a 6 wt % decane solution of a silicone resin (YSR3022 available from Momentive Performance Materials Japan LLC.) was prepared, and furthermore, a catalyst (YC6831 available from Momentive Performance Materials Japan LLC.) in an amount of 1% of a solid content of the silicone resin, and acetylacetone (available from FUJIFILM Wako Pure Chemical Corporation), as a curing retardant, in an amount of 3% of the solid content of the silicone resin were added thereto. The obtained solution was applied onto the porous support member. The solution was applied under the condition of a coating thickness of 68.6 μm using a bar coater. Next, the obtained coating film was dried at 130° C. for 5 minutes. Thereby, a laminate of the porous support member and an intermediate layer was obtained. The intermediate layer had a thickness of approximately 1 μm. Furthermore, the laminate was subjected to a corona treatment at an output of 0.1 kW.

Subsequently, a PVA aqueous solution and a PVP aqueous solution were prepared in the same manner as in Example A1. Next, 1.5 g of the PVA aqueous solution, 1.5 g of the PVP aqueous solution, 0.63 g of 1-ethyl-3-methylimidazolium dicyanamide ([EMIM][DCA]) as the ionic liquid L, and 0.018 g of a surfactant (SURFLON S-243 available from AGC Seimi Chemical Co., Ltd.) were mixed and stirred well until they dissolved completely. Thus, a mixed solution was obtained. The obtained mixed solution was applied onto the above-mentioned laminate to obtain a coating film. The mixed solution was applied under the condition at 1000 rpm using a spin coater. The coating film was left at 25° C. for one day or longer to be dried, and thereby a separation functional layer was produced. Thus, a separation membrane (composite membrane) of Example B1 was obtained.

### Examples B2 to B5

A separation membrane (composite membrane) of each of examples B2 to B5 was obtained in the same manner as in Example B1, except that the weight ratio of the ionic liquid L and that between the polymers A and B were changed as shown in Table 2.

### Example B6

A separation membrane (composite membrane) of Example B6 was obtained in the same manner as in Example B1, except that 1-ethyl-3-methylimidazolium tricyanomethanide ([EMIM][TCM]) was used as the ionic liquid L.

### Example B7

A separation membrane (composite membrane) of Example B7 was obtained in the same manner as in Example B1, except that the polymer B was not used and the weight ratio of the ionic liquid L with respect to the polymer A was 75/25.

### Example B8

First, a refluxing pipe was attached to a three-necked flask to assemble a synthesizing device. A vacuum pump and an N₂ cylinder were connected to a three-way cock. While vacuum suction was being performed, five cycles of nitrogen purge were performed, each cycle being an operation of supplying nitrogen once in 2 minutes. After the nitrogen purge, 1,4-dioxane was added into the three-necked flask using a glass syringe. Next, N,N-dimethylacrylamide (DMAAm) (14.6 g, 147.28 mmol), N-acryloyloxysuccinimide (NSA) (1.32 g, 7.80 mmol), and 2,2′-azobisisobutyronitrile (AIBN) (0.256 g, 1.56 mmol) were weighed out and put in a vial bottle in this order and stirred for a few minutes. The molar ratio between the DMAAm and the NSA (DMAAm/NSA) was 95/5. The obtained mixture was added into the three-necked flask using a syringe. The solution in the three-necked flask was stirred with a stirrer for approximately 10 minutes. Next, the refluxing pipe was connected to a cooling device, and polymerization was performed for 24 hours under reflux using an oil bath set at 60° C.

The solution after the polymerization was transferred to an eggplant flask and subjected to a treatment by an evaporator at 60° C. for 30 minutes or longer to remove the 1,4-dioxane from the solution. Next, THF was added into the eggplant flask to dissolve a white solid. Next, the obtained solution was dropped, using a dropper, by one drop at a time to hexane cooled at −10° C. while the mixture was being stirred thus to obtain a precipitate. The precipitate was subjected to a treatment using a constant temperature bath at 30° C. for 24 hours in a vacuum atmosphere thus to obtain a prepolymer (poly(DMAAm-co-NSA)).

Next, polyvinyl alcohol (PVA, available from Sigma Aldrich, weight-average molecular weight 85000 to 124000, saponification degree 87 to 89 mol %) as the polymer A was added to water and the resultant was heated to 90° C. The resultant was stirred until the PVA dissolved completely to prepare a PVA aqueous solution. The above-mentioned prepolymer (poly (DMAAm-co-NSA)) was added to this PVA aqueous solution and stirred for 1 hour. Furthermore, 1-ethyl-3-methylimidazolium dicyanamide ([EMIM][DCA]) as the ionic liquid L was added and stirred for 30 minutes. Diethylene glycol bis(3-aminopropyl) ether as the crosslinking agent was added to the obtained mixed solution and stirred for 3 minutes. Thereby, a mixed solution for forming the separation functional layer was produced.

Next, the obtained mixed solution was applied onto a laminate of the porous support member and the intermediate layer to obtain a coating film. As the laminate of the porous support member and the intermediate layer, the laminate (the laminate subjected to a corona treatment at an output of 0.1 kW) mentioned above in Example B1 was used. The mixed solution was applied under the condition at 1000 rpm using a spin coater. Next, the coating film was left at 25° C. for one day or longer to be dried. Thereby, a reaction between the prepolymer and the crosslinking agent proceeded to form the polymer B, and thus a separation membrane (composite membrane) of Example B8 was obtained. Note that in this separation membrane, the weight ratio of the ionic liquid L with respect to the polymers (the polymers A and B) was 75/25, and the weight ratio (A/B) of the polymer A with respect to the polymer B was 71/29.

### Example B9

It was tried to produce a separation membrane (composite membrane) in the same manner as in Example B1, except that the polymer A was not used and the weight ratio of the ionic liquid L with respect to the polymer B was 75/25. However, the mixed solution failed to be sufficiently solidified and it was impossible to obtain the separation functional layer.

### [Gas Permeation Test]

By the method mentioned above for Examples A1 to A4, the separation membrane of each of Examples B1 to B8 was measured for the permeance T2 of carbon dioxide, and the separation factor α2 (CO₂/H₂) of the separation membrane for carbon dioxide with respect to hydrogen was measured. Table 2 shows the results.

TABLE 2

| | | Example | Example | Example | Example | Example | Example | Example | Example | Example |
|---|---|---|---|---|---|---|---|---|---|---|
| | | B1 | B2 | B3 | B4 | B5 | B6 | B7 | B8 | B9 |
| Polymer A | | PVA | PVA | PVA | PVA | PVA | PVA | PVA | PVA | — |
| Polymer B | | PVP | PVP | PVP | PVP | PVP | PVP | — | Crosslinked | PVP |
| | | | | | | | | | product of | |
| | | | | | | | | | PDMAAm | |
| Ionic liquid | | [EMIM] | [EMIM] | [EMIM] | [EMIM] | [EMIM] | [EMIM] | [EMIM] | [EMIM] | [EMIM] |
| | | [DCA] | [DCA] | [DCA] | [DCA] | [DCA] | [TCM] | [DCA] | [DCA] | [DCA] |
| Weight ratio | | 75/25 | 85/15 | 65/35 | 75/25 | 75/25 | 75/25 | 75/25 | 75/25 | 75/25 |
| (Ionic liquid/Polymer(s)) | | | | | | | | | | |
| Weight ratio | | 71/29 | 71/29 | 71/29 | 50/50 | 29/71 | 71/29 | 100/0 | 71/29 | 0/100 |
| (Polymer A/Polymer B) | | | | | | | | | | |
| Composite | Thickness of separation | 1.2 | 1.6 | 2.1 | 1.0 | 1.4 | 0.7 | 1.2 | 1.6 | — |
| membrane | functional layer (μm) | | | | | | | | | |
| | CO₂ permeance T2 | 125 | 154 | 91 | 138 | 187 | 101 | 58 | 124 | — |
| | (GPU) | | | | | | | | | |
| | CO₂/H₂ separation factor | 12 | 12 | 8 | 10 | 9 | 9 | 9 | 12 | — |
| | α2 (—) | | | | | | | | | |

As understood from Table 2, the separation membrane of each of Examples B1 to B8 that included the separation functional layer including at least the polymer A exhibited excellent carbon dioxide permeation performance.

### Example C1

A separation functional layer (self-supporting membrane) of Example C1 was obtained in the same manner as in Example A4, except that polyvinyl alcohol a1 (PVA, available from Tokyo Chemical Industry Co., Ltd., polymerization degree 2000, weight-average molecular weight 88000, saponification degree 80 mol %) was used as the polymer A and the weight ratio of the ionic liquid L with respect to the polymer A was 40/60.

### Example C2

A separation functional layer (self-supporting membrane) of Example C2 was obtained in the same manner as in Example C1, except that polyvinyl alcohol a2 (PVA, available from Sigma Aldrich, weight-average molecular weight 85000 to 124000, saponification degree 87 to 89 mol %) was used as the polymer A.

### Example C3

A separation functional layer (self-supporting membrane) of Example C3 was obtained in the same manner as in Example C1, except that polyvinyl alcohol a3 (PVA, available from Sigma Aldrich, weight-average molecular weight 85000 to 124000, saponification degree 99 mol %) was used as the polymer A.

### Examples C4 to C12

A separation functional layer (self-supporting membrane) of each of Examples C4 to C12 was obtained in the same manner as in Example C1, except that the type of the polymer A and the weight ratio of the ionic liquid L with respect to the polymer A were changed as shown in Table 3.

### [Compression Test]

The separation functional layer of each of Examples C1 to C12 was subjected to a compression test in the same manner as mentioned above. Here, the ratio (leakage rate) of the weight of the ionic liquid that leaked from the separation functional layer when the separation functional layer was subjected to the compression test with respect to the weight of the ionic liquid L included in the separation functional layer was specified. Table 3 shows the results.

### [Tensile Test]

The separation functional layer of each of Examples C1 to C12 was subjected to a tensile test in the same manner as mentioned above and measured for fracture energy and breaking strength (fracture stress). Table 3 shows the results.

TABLE 3

| | | Example | Example | Example | Example | Example | Example |
|---|---|---|---|---|---|---|---|
| | | C1 | C2 | C3 | C4 | C5 | C6 |
| Polymer A | Type | a1 | a2 | a3 | a1 | a2 | a3 |
| (PVA) | Saponification | 80 | 87-89 | 99 | 80 | 87-89 | 99 |
| | degree (mol %) | | | | | | |
| Ionic liquid | | [EMIM] | [EMIM] | [EMIM] | [EMIM] | [EMIM] | [EMIM] |
| | | [DCA] | [DCA] | [DCA] | [DCA] | [DCA] | [DCA] |
| Weight ratio | | 40/60 | | | 50/50 | | |
| (Ionic liquid/Polymer) | | | | | | | |
| Self- | Fracture | 48019 | 70945 | 48882 | 50593 | 36526 | 43074 |
| supporting | energy (kJ/m³) | | | | | | |
| membrane | Fracture stress | 10636 | 14651 | 20115 | 10298 | 9691 | 14814 |
| | (kPa) | | | | | | |
| | Leakage rate | 0 | 0 | 0 | 0 | 0 | 0.69 |
| | (wt %) | | | | | | |
| | | Example | Example | Example | Example | Example | Example |
| | | C7 | C8 | C9 | C10 | C11 | C12 |
| Polymer A | Type | a1 | a2 | a3 | a1 | a2 | a3 |
| (PVA) | Saponification | 80 | 87-89 | 99 | 80 | 87-89 | 99 |
| | degree (mol %) | | | | | | |
| Ionic liquid | | [EMIM] | [EMIM] | [EMIM] | [EMIM] | [EMIM] | [EMIM] |
| | | [DCA] | [DCA] | [DCA] | [DCA] | [DCA] | [DCA] |
| Weight ratio | | 60/40 | | | 75/25 | | |
| (Ionic liquid/Polymer) | | | | | | | |
| Self- | Fracture | 36168 | 25072 | 36152 | 6835 | 10535 | 3665 |
| supporting | energy (kJ/m³) | | | | | | |
| membrane | Fracture stress | 7965 | 6460 | 11868 | 1489 | 2245 | 1627 |
| | (kPa) | | | | | | |
| | Leakage rate | 0 | 0.72 | 2.78 | 0 | 2.13 | 9.66 |
| | (wt %) | | | | | | |

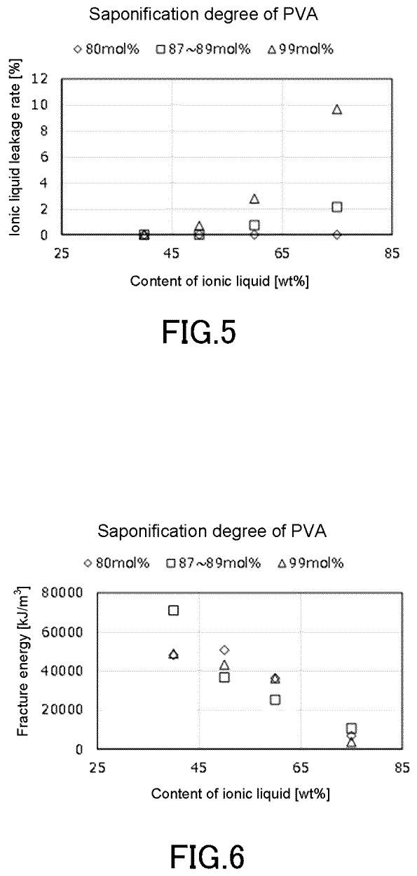

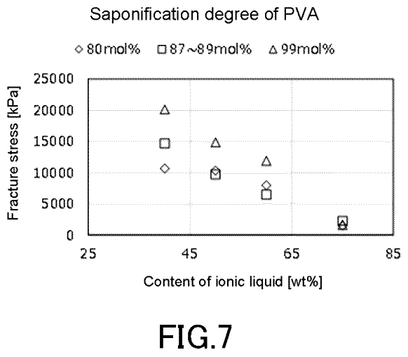

FIGS. 5 to 7 each are a graph showing a relation between the content of the ionic liquid and each characteristic of the separation functional layer of each of Examples C1 to C12. As understood from Table 3 and FIGS. 5 to 7 (particularly FIG. 5), use of PVA with a low saponification degree tends to allow the separation functional layer to have more suppressed leakage of the ionic liquid. Note that these results also reveal that the saponification degree of PVA does not significantly affect the mechanical strength of the separation functional layer.

### INDUSTRIAL APPLICABILITY

The separation functional layer and the separation membrane of the present embodiment are suitable for separating an acid gas from a gas mixture containing the acid gas. In particular, the separation functional layer and the separation membrane of the present embodiment are suitable for separating carbon dioxide from an off-gas from a chemical plant or a thermal power plant.

1. A separation functional layer comprising:
an ionic liquid;
a polymer A that is hydrophilic and forms a crystal structure in the ionic liquid; and
a polymer B different from the polymer A.

2. The separation functional layer according to claim 1, wherein the ionic liquid is hydrophilic or amphiphilic.

3. The separation functional layer according to claim 1, wherein the ionic liquid contains at least one selected from the group consisting of 1-ethyl-3-methylimidazolium dicyanamide and 1-ethyl-3-methylimidazolium tricyanomethanide.

4. The separation functional layer according to claim 1, wherein the polymer A has a hydroxyl group.

5. The separation functional layer according to claim 4, wherein the polymer A is bonded to the polymer B via a hydrogen bond derived from the hydroxyl group.

6. The separation functional layer according to claim 1, wherein the polymer A includes polyvinyl alcohol.

7. The separation functional layer according to claim 1, wherein the polymer B has at least one selected from the group consisting of an amide group and an imide group.

8. The separation functional layer according to claim 1, wherein the polymer B is linear.

9. The separation functional layer according to claim 1, wherein the polymer B includes polyvinylpyrrolidone.

10. The separation functional layer according to claim 1, wherein a content of the ionic liquid is 60 wt % or more.

11. The separation functional layer according to claim 1, having a thickness of 100 μm or less.

12. The separation functional layer according to claim 1, having a breaking strength of 100 kPa or more.

13. The separation functional layer according to claim 1, wherein when a gas mixture composed of carbon dioxide and hydrogen is supplied to a space adjacent to one surface of the separation functional layer while a space adjacent to another surface of the separation functional layer is decompressed, a permeability of carbon dioxide permeating through the separation functional layer is 100 Barrer or more,
a concentration of the carbon dioxide in the gas mixture is 50 vol % under a standard condition, the gas mixture supplied to the space adjacent to the one surface has a temperature of 30° C. and a pressure of 0.1 MPa, and the space adjacent to the other surface is decompressed in such a manner that a pressure in the space adjacent to the other surface is lower than an atmospheric pressure in a measurement environment by 0.1 MPa.

14. The separation functional layer according to claim 1, being for use in separating an acid gas from a gas mixture containing the acid gas.

15. A separation membrane comprising:
the separation functional layer according to claim 1; and
a porous support member supporting the separation functional layer.

16. A separation membrane comprising:
a separation functional layer; and
a porous support member supporting the separation functional layer, wherein
the separation functional layer includes an ionic liquid, and a polymer A that is hydrophilic and forms a crystal structure in the ionic liquid.
